(19) United States
(12) Patent Application Publication
(10) Pub. No.: US 2003/0080143 A1
(43) Pub. Date: May 1, 2003

(54) System and method for dispensing liquids

(75) Inventors: Samesh Kale, Burlington, MA (US); George Seward, Arlington, MA (US); Namyong Kim, North Andover, MA (US); Brian Cain, Arlington, MA (US); Timothy Moulton, Cambridge, MA (US); Michael Septak, Ashland, MA (US); Charles Burke, Mount Pleasant, MI (US); Douglas Bourn, Palo Alto, CA (US)

Correspondence Address: THOMAS P O'CONNELL, 135 CAMBRIDGE STREET SUITE 10, BURLINGTON, MA, 01803

(73) Assignee: Arradial, Inc., Bedford, MA

(21) Appl. No.: 10/117,720

(22) Filed: Apr. 4, 2002

Related U.S. Application Data
(60) Provisional application No. 60/281,489, filed on Apr. 4, 2001.

(51) Int. Cl. B67B 7/00

(52) U.S. Cl. 222/1

(57) ABSTRACT

A method for depositing a volume of fluid relative to a surface to produce a droplet relative to the surface comprising the steps of forming a bolus of liquid relative to a dispensing member, causing the bolus of liquid to make contact with a surface thereby forming a bridge of liquid between the dispensing member and the surface, and retracting only a portion of the bolus of liquid to break the bridge of liquid between the dispensing member and the surface thereby depositing a droplet on the surface. A volume of a droplet can be adjusted by forming a bridge of liquid between a dispensing member and a surface that includes an initial droplet and breaking the bridge of liquid while leaving a remaining droplet of a different volume than the initial droplet. One or more droplets can be interacted with by forming a bridge of liquid between a dispensing member and a surface that includes one or more of the droplet or droplets and drawing at least a portion of the bridge of liquid into an inner volume of the dispensing member.

### FIELD OF THE INVENTION

The present invention relates generally to methods and systems for dispensing liquids. Stated more particularly, this patent discloses and protects a system and method for storing, transporting, and dispensing droplets of liquid of precise and controllable volumes onto physical substrates.

### BACKGROUND OF THE INVENTION

The manipulation of small, such as sub-microliter, volumes of liquid has become of increasing importance in the pharmaceutical and health care industries. The advent of combinatorial chemistry coupled with high throughput screening has enabled pharmaceutical companies to screen millions of targets in search of potential drug candidates. As libraries have grown larger, the pharmaceutical industry has responded in part by hastening the screening process through automation. As a side effect of this drive towards faster discovery, the cost of consumable reagents has been skyrocketing as the volumes of required reagents have scaled with the increasing throughput brought on by automation.

To offset this cost, a secondary drive towards miniaturization has taken place in response to the drive for higher screening throughputs. As an example, if an assay of a 5 μl volume is reduced to a 100 nl volume assay, then reagent costs can be reduced from millions of dollars to tens of thousands of dollars during a screening of a library of 1 million compounds. A major hurdle in achieving these cost savings while maintaining data quality has been the high coefficient of variation found in existing dispensers at sub-microliter volumes. Variation in dispensing leads to errors in the signal-to-background ratio. Such errors can hide a successful drug from discovery.

The evolution of automation in the pharmaceutical industry has centered on the microtiter plate footprint. Early automation interfaced with a 96-well plate, and through subsequent iterations the instrumentation has evolved to the point where 384 and 1536 well formats have been implemented. However, the legacy issues surrounding the 96-well format pose problems for both small biotech companies and large pharmaceutical companies. The sheer physical size of a library stored in 96-well plates along with the automation infrastructure required to support the library prevents many small biotech companies from maintaining a large library onsite. Even large pharmaceutical companies have chosen to consolidate the library maintenance and screening infrastructure into a single core screening facility that services the various R&D groups. As a result, access to large libraries is becoming increasingly difficult.

In recent years, two predominant techniques for dispensing sub-microliter volumes of liquids for biotechnology applications have emerged. A first dispensing technique is jetting technology, which is based on the propagation of pressure waves through a channel, has enabled so-called “drop-on-demand” dispensing systems. Such systems allow streams of microdroplets ranging from picoliters to several microliters to be ejected from an orifice.

Unfortunately, such dispensing systems present issues in coefficients of variation (CV). At best, the CV for dispensing a single liquid is approximately 5%, while a typical CV is 15%. This problem is exacerbated when such systems are asked to dispense a variety of fluids. In those situations, the CV for droplets of different fluids can be as high as 110%. This inter-fluid droplet variation is typically due the sensitivity of these systems to the varying rheological properties of the fluid being dispensed. Examples of such systems include solenoid-based devices and piezoelectric devices.

The second dispensing technique is pin spotting wherein an array of precision machined pins or quills is dipped into a variety of solutions. As the pins are withdrawn, a given volume of fluid, such as from 100 pL to 100 nL, is retained on the tip of each pin depending in large part on the pin geometry. The pins are then brought into contact with a flat substrate, usually glass, and the fluid is transferred by touching off the pins. Typically, these systems demonstrate a CV in the range of 25-50%. Once again, these CV's typically stem from the variation in the rheological properties of the fluids.

In light of the foregoing, it becomes clear that there is a real need in the industry for improved systems and methods for depositing microdroplets onto substrates in small volumes with improved consistency and accuracy.

### SUMMARY OF THE INVENTION

Advantageously, the present invention is founded on the primary object of providing a system and method for dispensing small volumes of liquids that overcomes the disadvantages demonstrated by the prior art while providing a number of heretofore unrealized advantages thereover.

More particularly, a primary object of the invention is to provide a system and method that is able to dispense liquid droplets in the sub-microliter range with appreciably improved coefficients of variation.

A further object of the invention is to provide a system and method that is capable of aspirating liquids in the range of sub-microliter to 100 microliter, also with improved coefficients of variation.

Yet another object of the invention is to provide a system and method that can carry out rapid and efficient cycles of liquid dispensing and aspiration.

An even further object of the invention is to provide a system and method for dispensing droplets of liquid of accurately controllable volumes.

In certain embodiments, an object of the invention is to provide a system and method capable of selectively modifying a volume of a pre-existing droplet.

A still further object of certain embodiments of the invention is to provide a system and method for interacting with one or more droplets of liquid disposed on a substrate.

These and still further objects and advantages of the invention will be obvious not only to one who has reviewed the present specification and drawings but also to one who has an opportunity to observe an embodiment of the present invention in operation.

In carrying forth these objects, one embodiment of the invention essentially comprises a method for depositing a volume of fluid relative to a surface to produce a droplet relative to the surface. The method includes the provision of a dispensing member, a means for forming a bolus of liquid relative to the dispensing member, a means for retracting at least a portion of the bolus of liquid, and a surface for receiving the droplet. As a side note, one knowledgeable in the art will be aware that a bolus of liquid can be defined most generally as a rounded mass of liquid. With this, a bolus of liquid is formed relative to the dispensing member, and the bolus of liquid is caused to make contact with the surface. This forms what can be considered a bridge of liquid between the dispensing member and the surface. Then, a portion of the bolus can be retracted thereby breaking the bridge of liquid. With this, a droplet of liquid is deposited on the surface.

It will be appreciated that the bolus of liquid can be caused to make contact with the surface in a variety of ways. For example, the contact can be induced by growing the bolus, possibly with the dispensing member disposed at a given and fixed distance from the surface or with the dispensing member moving, for example, toward the surface. Alternatively, the contact can be induced by moving an already formed bolus and a location on the surface toward one another, which, of course, can be carried out by moving the dispensing member toward the location on the surface, moving the location on the surface toward the dispensing member, or by moving the locations of both the surface and the dispensing member toward one another. In any event, it should be clear that the step of forming the bolus could happen before or after the dispensing member and the surface are moved into proximity with one another. Preferably, the dispensing member will not be moved so far as to contact the surface once the bolus has been formed.

It must be noted that the present method could be carried out with dispensing members of a wide variety of constructions. In certain embodiments, the dispensing member will have an inner volume for retaining a volume of liquid and an orifice for allowing the passage of liquid therethrough. For example, the dispensing member can have an open proximal end, an open distal end, and an channel therebetween that comprises the inner volume. In such a case, the bolus of liquid can be considered a sub-volume of liquid that is forced out of the dispensing member in a temporary fashion such that continuity is maintained between the volume of liquid in the inner volume and the expelled sub-volume or bolus at all times. For the purposes of the present discussion, the proximal end of the dispensing member will be considered the end closer to the surface while the end further from the surface will be considered the distal end.

Even more preferably, the dispensing member will comprise a capillary tube that exerts capillary forces for acting at least partially as the means for retracting at the bolus. Where desirable or necessary, however, the capillary forces can be supplemented by a means for applying a suction force to the capillary tube. With such a dispensing member, the bolus can be formed by disposing a volume of liquid in the inner volume of the capillary tube, such as by drawing it in from a given source body of liquid or by filling the capillary through a fluid-supplying conduit or the like, and at least partially overcoming the capillary forces exhibited by the capillary tube, such as by applying an increased pressure to the inner volume of the capillary tube, to form the bolus of liquid at the proximal end of the capillary tube. That increase in pressure could be achieved by increasing a pressure relative to a second liquid or a vapor, such as air, that could be disposed in the inner volume of the capillary tube with the volume of the first liquid. Preferably, however, the increase in pressure will not be so much as to induce the bolus of liquid to drop or a flow of liquid to be emitted from the capillary tube.

Although not necessary to carrying out basic embodiments of the invention, a number of added functions and advantages can be accomplished by forming a second bridge of liquid between the proximal end of the capillary tube and the droplet that has been deposited on the surface. That second bridge can be formed by forming a second bolus and causing that second bolus to contact the droplet that was deposited on the surface. Alternatively, the second bridge can be formed by contacting the proximal end of the capillary tube with the droplet, such as by plunging the capillary tube into the droplet.

With the second bridge, the volume of the droplet advantageously can be adjusted, such as to achieve a desired droplet volume, by reducing or increasing the volume of the droplet as is necessary or desirable. For example, to reduce the volume of the droplet where a second bolus of liquid has been formed, a volume of liquid greater than a volume of the second bolus can be drawn into the inner volume of the capillary tube and the second bridge can be broken. To increase the volume of the droplet in the same situation, a volume of liquid less than the volume of the second bolus can be drawn and the second bridge can be broken.

In preferred embodiments, there will also be included a means for enabling a control of the volume of the droplet deposited on the surface. That means, of course, could take a variety of forms that could each act alone or in various combinations. For example, the present inventors have advantageously appreciated that, with a proper understanding of the technical aspects involved as will be discussed more fully below, the volume of the droplet to be deposited can be controlled by a control of the proximity of the dispensing member, such as the proximal end of the capillary tube, relative to the surface. The inventors have further appreciated that the volume of the droplet can be controlled by a control of the volume of the bolus, again with a proper understanding of a number of relevant factors. Of course, the control of the volume of the droplet will be greatly facilitated by the provision of a means for detecting the volume of the droplet and, additionally or alternatively, a means for detecting the volume of the bolus.

Even further, the volume of the droplet deposited on the surface can be affected and, to at least an extent, controlled by the application of a coating, such as a hydrophobic coating, to at least the proximal end of the elongate dispensing member for altering the free surface energy of the dispensing member. Additionally, a coating could be applied to the surface for altering its surface tension and thereby affecting the volume of the droplet deposited on the surface.

When the dispensing member includes an inner volume, the inventive method can further include retaining the volume of liquid in the inner volume for an amount of time sufficient to allow a process, such as an incubation process, to be completed. Where such a process is to be completed, the invention can additionally include a means, such as a light detector, for quantifying a status of the process to be completed in the volume of liquid.

It should be appreciated that the present invention can also be practiced where there is an initial droplet on the surface so that the droplet is deposited relative to the initial droplet. In such a case, some or all of the droplet and the initial droplet can be drawn into the dispensing member where they can be retained and allowed to interact, such as in an incubation or other process.

In another embodiment, the invention can be described as a method for adjusting a volume of an initial droplet on a surface. In this case, the method comprises providing a dispensing member, such as a capillary tube, and a surface with an initial droplet disposed thereon. That initial droplet could be dispensed according to the present invention, or it could be pre-existing or applied by any other method. A bridge of liquid can be formed between the dispensing member and the surface with that bridge of liquid including the initial droplet. Then, the bridge of liquid can be broken while leaving behind a remaining droplet of a different volume than the initial droplet.

The second bridge can be formed by contacting a proximal surface of the dispensing member with the initial droplet or by forming a bolus of liquid relative to the dispensing member and causing that bolus to make contact with the initial droplet. The remaining droplet can be made smaller than the initial droplet by aspirating a volume of liquid greater in volume than the volume of the bolus wherein that volume of liquid comprises at least a portion of the bolus and at least a portion of the initial droplet. The remaining droplet can be made larger than the initial droplet by aspirating a volume of liquid lesser in volume than the volume of the bolus.

In a further aspect, the invention can be said to comprise a method for interacting with at least one droplet on a surface wherein the method is founded on providing a surface with at least one droplet disposed thereon, providing a dispensing member, and providing a means for drawing a volume of liquid into an inner volume of the dispensing member. Again, the initial droplet could be applied by any method, including according to the present invention. With these elements provided, a bridge of liquid can be formed between the dispensing member and the surface with the bridge including the at least one droplet. At least a portion of the bridge of liquid can be drawn into the inner volume of the dispensing member with that at least a portion of the bridge of liquid including at least a portion of the at least one droplet. The bridge can then be broken whereby the at least a portion of the at least one droplet can be retained in the inner volume of the dispensing member.

Although interacting with one droplet can achieve a plurality of objects and advantages of the invention, other and further objects can be accomplished by interacting with a plurality of droplets on a given surface. The bridge of liquid could be formed to include one of the droplets or to include a multiplicity and possibly all of the droplets, and at least a portion of each of the multiplicity of droplets can be aspirated into the dispensing member and simultaneously retained therein to allow an interaction therebetween. With this, droplets of different compositions can be aspirated such that the inner volume can act as an incubation chamber or the like. Where processes are to be allowed to occur in the dispensing member, the invention can further include a means for detecting a status of such processes.

Under such preferred embodiments of the invention, liquids can be dispensed in the sub-microliter range with coefficients of variation that can range between 5% and 15%. Furthermore, liquids can be aspirated in the sub-microliter range with commensurate coefficients of variation. Additionally, when necessary, a complete dispensing and aspiration cycle can be carried out with a frequency on the order of 10 Hz. Even further, in particular embodiments, the invention can enable a closed-loop control system that operates in real time. In still more preferred embodiments, the inventive system and method can monitor droplet volumes in real-time while also correcting for dispensing errors by the addition or removal of volumes, such as picoliters, of liquid from the initial droplet. With that, the present system and method can dispense volumes throughout a wide range, such as from several picoliters to a microliter. Most advantageously, such dispensing can be carried out with coefficients of variation of less than 1% thereby defining a marked improvement over the prior art. Even more advantageously, the system and method can do so while dealing with a variety of liquids with different rheological properties. The simultaneous ability to dispense small volumes while exhibiting exemplary coefficients of variation represents a marked advance over prior art methods and systems. Still further advantages can be derived from the large dynamic range of dispensing volumes in combination with the reduced coefficients of variation achievable under embodiments of the present invention.

Even further, embodiments of the present invention enable a macro-to-micro interface for the handling and storage of liquids with a minimum dead volume, which represents a marked improvement over the prior art. For example, one knowledgeable in the art will be aware that jetting technologies typically have dead volumes as high as several microliters. The present system and method, meanwhile, can demonstrate a dead volume as low as several picoliters to hundreds of nanoliters with a typical dead volume of 50 nL. This capability, in turn, allows the storage of liquids in a format of sufficient density to enable automatable access to compound libraries of approximately 200,000 compounds in a volume of approximately 8 ft³.

In still another embodiment of the invention, after a first droplet has been deposited on the physical substrate, one or more additional droplets can be deposited over the first droplet to form a final droplet. Henceforth, this final droplet will be called the assay droplet. Preferably, the first and additional droplets will comprise, for example, aqueous salt solutions or solvents containing proteins, such as enzymes, small molecules, such as drugs, cells, or fluorogenic compounds of varying concentrations.

With this, biochemical reactions can take place within the assay droplet using a mixture of the previously mentioned reagents to test the activity and specificity of enzymes and drugs. Furthermore, the system can measure the residual activity and kinetics of those enzymes and drugs in the presence of an inhibitor or an activator. A homogeneous assay contains only liquids, while cell-based bioassays contain living cells and heterogeneous assays contain pre-immobilized binding partners. Such cell-based assays are critical in the path of drug discovery and toxicity.

After the assay droplet has been deposited on the physical substrate by the dispensing member and the reagents have been adequately mixed, a capillary devoid of reagents can then be positioned above the assay droplet and used to retract the assay droplet. Similarly, a fresh dispensing member that contains at least one pre-immobilized binding partner can be used to receive the assay droplet to enable heterogeneous assays to be run. Alternatively, the assay volume can be formed within an empty capillary by aspirating a sequence of droplets.

One will appreciate that the foregoing discussion broadly outlines certain more important features of the invention to enable a better understanding of the detailed description that follows and to instill a better appreciation of the inventors' contribution to the art. Before any embodiment of the invention is explained in detail, it must be made clear that the following details of construction, descriptions of geometry, and illustrations of inventive concepts are mere examples of the many possible manifestations of the invention.

### BRIEF DESCRIPTION OF THE DRAWINGS

In the accompanying drawing figures:

FIG. 1 depicts a droplet on a substrate;

FIG. 2A is a sectional view of a capillary structure according to the present invention;

FIG. 2B is a sectional view of an alternative capillary structure;

FIG. 2C is a sectional view of another capillary structure;

FIG. 2D is a sectional view of a capillary nozzle with a flat end;

FIG. 2E is a sectional view of a capillary nozzle with an angled end;

FIG. 3 is a sectional view of a capillary structure according to the present invention;

FIG. 4A is a schematic of a two-valve pulse-generation system;

FIG. 4B is a timing diagram for the two-valve pulse-generation system;

FIG. 5A depicts a volume of liquid held within a capillary;

FIG. 5B depicts a bolus formed relative to a capillary;

FIGS. 6A-6D depict a process of droplet deposition on a substrate according to the present invention;

FIGS. 7A-7E depict certain major forces involved in the process of droplet deposition according to the present invention;

FIG. 8A is a plot of droplet volume versus capillary-substrate distance;

FIG. 8B is a plot of droplet volume versus capillary-substrate distance for two surface treatments of the substrate;

FIG. 9 depicts a plurality of droplets deposited relative to a substrate with a surface topology;

FIG. 10 depicts a plurality of droplets deposited relative to a substrate with surface patterning;

FIG. 11A is a sectional view of a capillary retaining a volume of liquid with liquid menisci;

FIG. 11B is a sectional view of a fluorescent detection arrangement according to the present invention;

FIG. 12A depicts a transverse vision system according to the present invention;

FIG. 12B depicts a transverse image;

FIG. 13A depicts a normal vision system;

FIG. 13B depicts the path of light rays within the normal vision system;

FIG. 14A is a schematic depiction of unbound molecules;

FIG. 14B is a schematic depiction of bound and unbound molecules;

FIG. 15A is a view in side elevation of a droplet of an incubated solution disposed on a substrate;

FIG. 15B depicts bound molecules disposed on a substrate;

FIG. 16A depicts a capillary-to-capillary liquid transfer arrangement; and

FIG. 16B depicts an alternative capillary-to-capillary liquid transfer arrangement.

### DETAILED DESCRIPTION

As is the case with many inventions, the present invention for a system and method for dispensing liquids is subject to a wide variety of embodiments. However, to ensure that one skilled in the art will be able to understand and, in appropriate cases, practice the present invention, certain preferred embodiments of the broader invention revealed herein are described below and shown in the accompanying drawing figures.

The present invention requires for its achievement a proper foundational understanding of the physics involved in its practice. Therefore, one will first note that a small volume of liquid is driven towards the shape of a sphere by the intermolecular attractions of the liquid. In the absence of pressure gradients created by gravitational forces, the pressure difference across the liquid-vapor interface is described as

$${P}_{LV} = \frac{2 {γ}_{LV}}{{R}_{LV}}$$

in which: γₗᵥ is the surface tension of the liquid-vapor interface and R_{LV} is the radius of curvature of the liquid-vapor interface. In this format, the surface tension has units of force per distance. Expanding the surface area of the volume tends to work against the pressure that drives the volume into a sphere. Thus, any increase in surface area represents an increase in stored energy, just as pushing a mass uphill to a higher elevation increases the gravitational potential energy. The amount of energy stored within the surface of the sphere is

E_{LV}=γₗᵥ4πR_{LV}²

wherein γₗᵥ now describes the energy per surface area of the liquid-vapor interface. Henceforth in this discussion, surface energy describes the total energy stored by a surface, and surface tension describes the energy per area of that surface area.

The surface energy of a liquid volume can be reduced by breaking the volume into smaller pieces with a smaller total surface area. This effect is evident in a stream of liquid. Such a stream first experiences necking where only portions of the stream diameter are reduced by surface tension. As this necking continues, the stream breaks into a sequence of discrete droplets. Such a series of droplets displays significant variation in droplet size. A similar effect occurs in a bridge of liquid between two surfaces.

The forces driving the necking and subsequent breaking are described by Young's equation. Young's equation specifies the pressure difference across an arbitrary surface as

$${P}_{LV} = {γ}_{LV} ( \frac{1}{{R}_{1}} + \frac{1}{{R}_{2}} )$$

in which R₁ and R₂ are the radii of curvature of the surface within two perpendicular planes at normal to the surface. The following configurations provide insight to the radii of curvature in Young's equation. An ellipsoid or bulge has two dissimilar positive radii of curvature. A cylinder has a first radius at infinity and a second radius at a positive finite value. A neck has two radii of curvature with opposite polarities.

As a sphere of liquid grows, the gravitational force flattens the spherical profile. The pressure differential due to gravity is expressed as

P_{LV}=(ρ_{L}−ρ_{V})g(z−z₀)

in which: ρ_{L} is density of the liquid, ρ_{V} is density of the vapor, g is the acceleration of gravity; and z is the elevation, and z₀ is the elevation of the crest of liquid. Over small ranges of elevation, the effects of gravity are negligible. Over large ranges of the elevation, the pressure difference created by gravity affects the surface profile in a complex manner. The energy due to gravitational force is

$${E}_{G} = {\int }_{L} ( {ρ}_{L} - {ρ}_{V} ) gz ⅆ x ⅆ y$$

in which the integral occurs over the volume of the liquid.

A droplet sitting atop a substrate is commonly referred to as a sessile drop. There are three interfaces of the sessile drop: liquid-vapor, liquid-substrate, and substrate-vapor. The total energy of the system is expressed as

$$E = \sum {γ}_{n} {A}_{n} + {\int }_{L} ( {ρ}_{L} - {ρ}_{V} ) gz ⅆ x ⅆ y$$

in which: γₙ is the surface tension of an interface, Aₙ is the corresponding surface area, and the integral describes the gravitation energy of the liquid. In the absence of gravity, the three surface tensions drive the profile into a spherical cap atop the substrate. If the surface tension of the liquid-substrate dominates, then the liquid wets the surface by expanding along the substrate until a thin film covers the substrate. If the surface tension of the liquid-vapor dominates, then the liquid forms a spherical bead atop the substrate. The spherical bead can exceed a hemisphere. As gravitational energy becomes significant, the bead departs from a spherical profile by flattening.

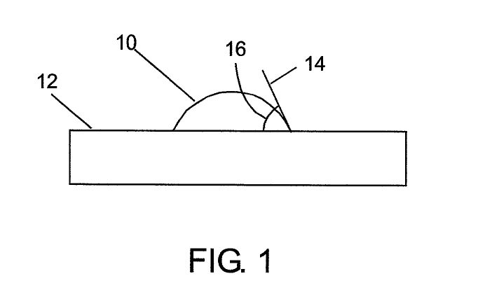

Looking more particularly to the drawings, FIG. 1 depicts a droplet 10 on a physical substrate 12. The angle of the droplet profile with respect to the angle of the plane of the substrate 12 can provide important information about surface tension. The tangent 14 to the droplet profile at the intersection of the droplet profile and the substrate surface defines the contact angle 16. The contact angle 16 is related to surface energies as

γ_{LV} cos θ_{C}=γ_{LS}−γ_{SV}

in which: γhd LV is the surface tension of liquid-vapor interface, γ_{LS} is the surface tension of liquid-substrate interface, γ_{SV} is the surface tension of substrate-vapor interface, and θ_{C} is the contact angle 16.

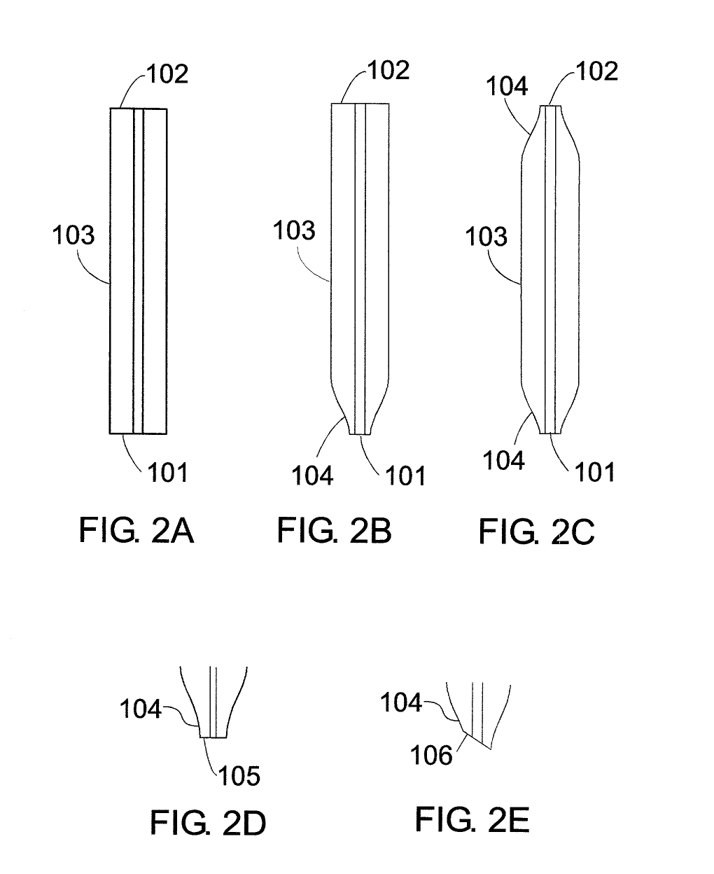

A typical capillary 100, such as that indicated generally at in FIGS. 2A-E, basically comprises a rigid tube with an inner diameter sufficiently small for capillary action to occur. Capillary action describes the intermolecular forces between a liquid and the capillary wall. The surface energy of the system includes several interfaces: liquid-vapor, liquid-capillary, and capillary-vapor. The total surface energy of the liquid within the capillary 100 can be energetically favorable to other configurations of the liquid. Consequently, a volume of liquid can be disposed in the channel within the capillary 100 by any appropriate method. For example, the proximal or the distal end 101 or 102 of the capillary 100 can be dipped or plunged into a source of liquid (not shown), and a portion of that liquid can be drawn or aspirated or otherwise drawn into the channel to as a volume of liquid 218, which forms a column of liquid 222 within the capillary 100. Additionally or alternatively, liquid could be loaded into, for example, the distal end 102 of the capillary 100 from a source of liquid, such as a liquid-supplying conduit or the like.

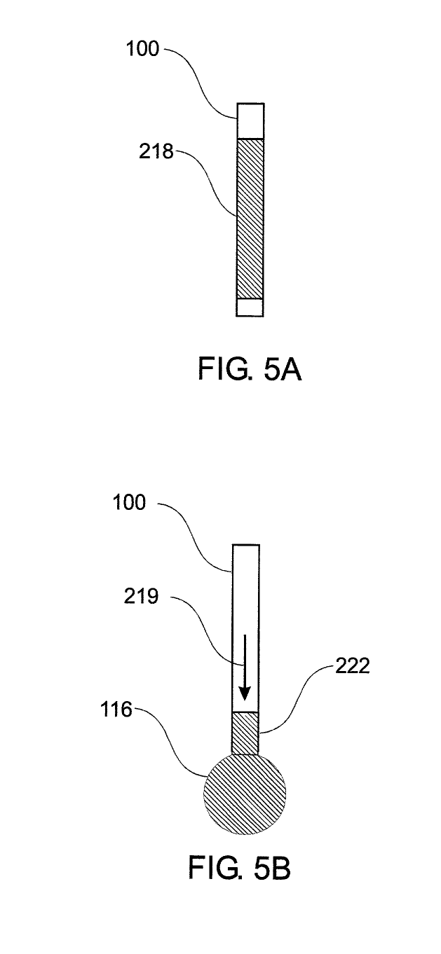

In any event, when a sphere of liquid is drawn into the channel of the capillary 100, the liquid's surface area is greatly increased but the surface energy of the system is decreased. The resulting volume of liquid 218 forms a column of liquid 222 within the capillary 100 as displayed in FIGS. 5A and 5B. Conversely, the column of liquid 222 within the capillary 100 can be displaced by a force 219 within the capillary 100. Such displacing of the column of liquid 222 creates a bolus of liquid 116 outside the capillary 100 as displayed in FIG 5B.

The capillary action can be countered by gravity. At some point, the gravitational and capillary forces are in balance at which point the capillary stops drawing liquid into its channel. The total energy at rest is described by

$$E = \sum {γ}_{n} {A}_{n} + {\int }_{L} ( {ρ}_{L} - {ρ}_{V} ) gz ⅆ x ⅆ y$$

in which: γₙ is the surface tension of an interface, Aₙ is the corresponding surface area, and the integral describes the gravitation energy of the liquid.

Displacement describes a motion of liquid created by application of an external force. Such a force can be a second liquid driven through the capillary 100 or a modified vapor pressure at only one end of the capillary 100. Typically, displacement is used to drive the liquid from the capillary 100. It can also be used to draw more liquid into the capillary 100. The additional energy created by displacement is

$${E}_{D} = {\int }_{D} {P}_{D} ⅆ x ⅆ y ⅆ z ,$$

in which P_{D} is the pressure by displacement is integrated over the volume of displacement. As the liquid exits the capillary 100, a rounded mass or bolus 116 of liquid forms. The bolus 116 essentially comprises a volume of liquid defined in part by a liquid-vapor interface. The shape of the bolus 116 is further defined by interactions with additional interfaces.

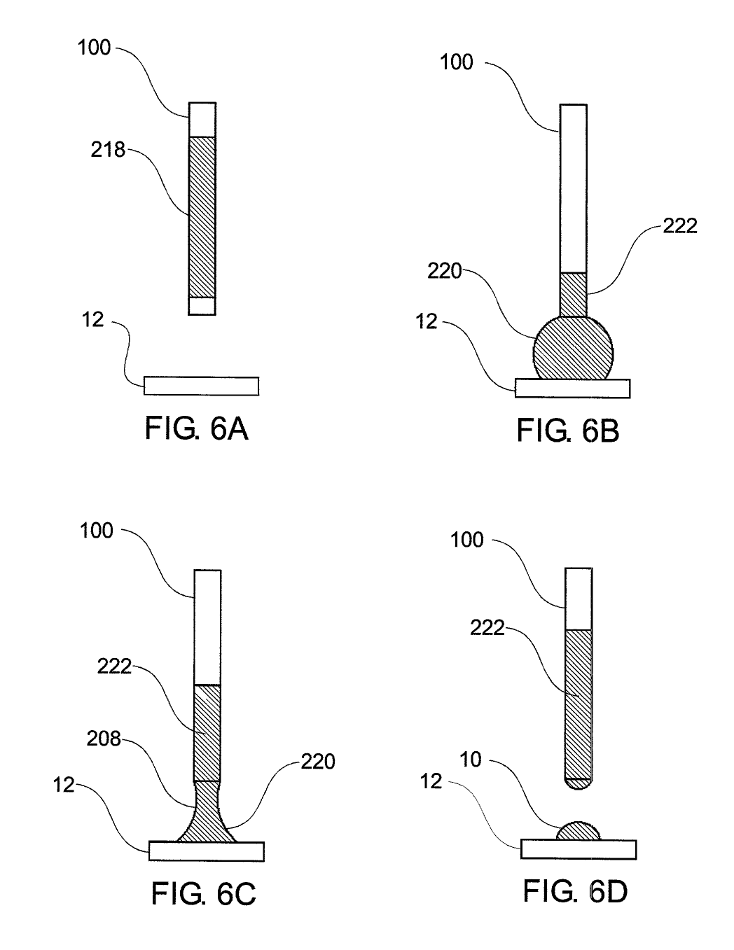

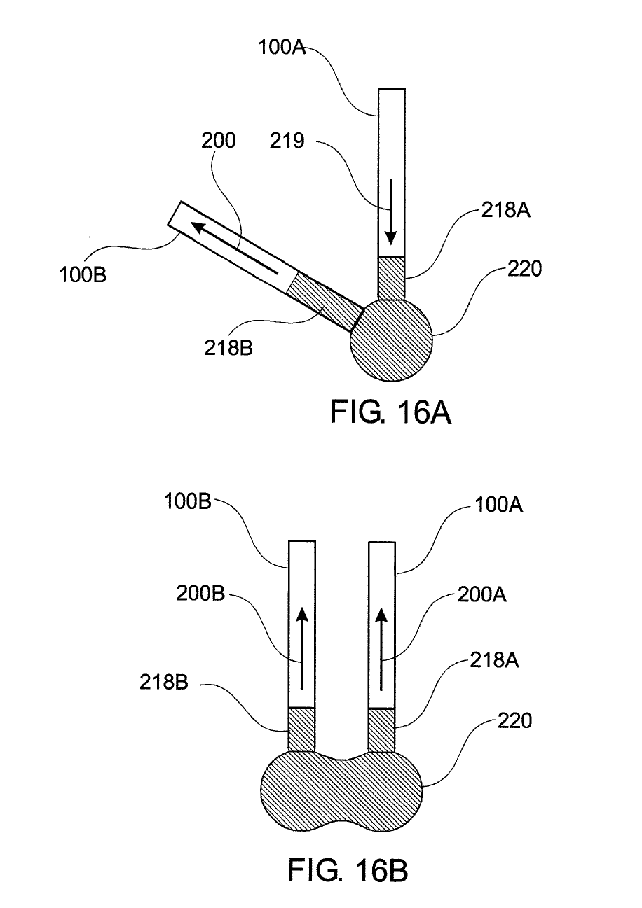

A bridge, such as that shown at 220 in FIGS. 6B and 6C, essentially comprises a continuous volume of liquid between, for example, the capillary 100 and the surface or physical substrate 12. Under the present invention, it should be clear that, except where otherwise specified, the term surface should be read to include any material or structure onto which a droplet 10 of liquid can be deposited. Accordingly, it will be appreciated that droplets 10 can be deposited or dispensed onto flat physical substrates 12, such as flat slides. As discussed below, droplets 10 could also be deposited onto substrates 12 that are patterned with, for example, regions of different surface energies, onto substrates 12 that are structured to provide added functionality, such as the detection of assay results during and after an incubation period. Even further, as is depicted in FIGS. 16A and 16B and with additional reference to FIGS. 2A-2C, droplets 10 could be deposited under the present invention from one dispensing member, such as from a proximal end 101 of a first dispensing capillary 100A, relative to another dispensing member, such as onto and into a proximal end 101 of a second transfer capillary 100B. Still further, as is also discussed herein, droplets 10 could be dispensed relative to one or more pre-existing droplets, onto beads, onto optical fibers, and onto substantially any other possible surface.

Looking more particularly to FIGS. 16A and 16B, one sees two possible embodiments of capillary-to-capillary transfer of liquid. In FIG. 16A, a transfer capillary 100B acts as a surface or substrate for receiving a droplet of liquid from the dispensing capillary 100A. To do so in this embodiment, the transfer capillary 100B is placed at an angle to the dispensing capillary 100A. Application of a motive force 219 to a first volume of liquid 218A creates a liquid bridge 220 between the dispensing capillary 100A and the transfer capillary 100B. The capillary force 200 within the transfer capillary 100B draws a portion of the liquid bridge 220 into the transfer capillary 100B as a droplet or second volume of liquid 218B.

Alternatively, as is shown in FIG. 16B, a transfer capillary 100B with an initial volume of liquid 218B can act as a surface or substrate by forming a bolus concurrently with the dispensing capillary 100B. Each bolus contacts the other resulting in a bridge of liquid 220 between the two capillaries 100A and 100B. Fluid exchange occurs across the bridge of liquid 220. Some or all of the mixed fluid bridge of liquid 220 can be retracted into either capillary 100A or 100B via capillary force 200A or 200B and, additionally or alternatively, by other forces, such as by application of a lower pressure.

The bridge 220 can be formed in a number of ways, including by growing the bolus 116 from the capillary 100 until it bridges the gap to the substrate 12. The bridge 220 can also be formed by moving a static bolus 116 on the capillary 100 into contact with the substrate 12 by moving the capillary 100 toward the substrate 12, by moving the substrate 12 toward the capillary 100, or by moving both the capillary 100 and the substrate 12 toward one another.

It should be noted that displacement within the capillary 100 can also be employed to break the bridge 220. As the displacement draws liquid into the capillary 100, necking occurs within the bridge 220. As the neck of the bridge 220 narrows, a break becomes energetically favorable. After the break, two separate volumes of liquid remain. A first volume of liquid comprises the remainder of the bolus 116, which is drawn into the capillary 100. A second volume of liquid is drawn to the substrate 12 where it forms the sessile drop or droplet 10. The volume of the droplet 10 is dependent upon numerous parameters of the system and method.

Both before and after the break, the total energy of the system is described by

$$E = \sum {γ}_{n} {A}_{n} + {\int }_{L} ( {ρ}_{L} - {ρ}_{V} ) gz ⅆ x ⅆ y$$

in which γₙ is the surface tension of an interface, Aₙ is the corresponding surface area, and the integral describes the gravitation energy of the liquid. During the break, there is additional energy due to the motion of the liquid. Both capillary action and displacement can draw at least part of a sessile droplet 10 into the capillary 100. Henceforth, this process will be referred to as aspiration. Aspiration can also be employed to draw liquid from a storage vessel (not shown).

Turning again to the structure of the capillary 100, one will appreciate that a typical capillary 100 has a through-channel and can be made of any solid material, such as metal, glass, ceramics, and plastics. Preferably, the capillary 100 has a first or proximal end 101, a second or distal end 102, and a body 103 of straight, cylindrical shape as shown in FIGS. 2A-2C. The capillary 100 can have a tapered nozzle 104 at one end 101 or 102 as shown in FIG. 2B or it can have tapered nozzles 104 at both ends 101 and 102 as shown in FIG. 2C. The nozzle 104 of a capillary 100 can have either a flat end 105 as shown in FIG. 2D or an angled end 106 as shown in FIG. 2E.

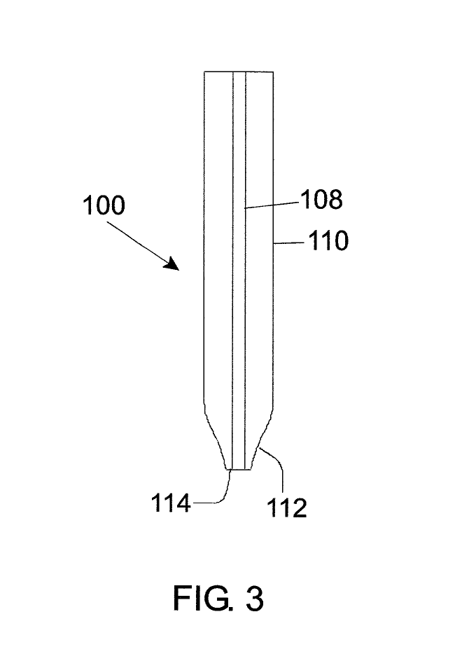

The inner surface 108, which defines an inner channel, and the outer surfaces 110, 112, and 114 of the capillary 100 are shown in FIG. 3. The outer surfaces include the cylindrical body exterior 110, the nozzle exterior 112, and the nozzle end 114. These surfaces can be manipulated to possess specific surface tensions for optimizing the performance of the capillary 100 in storing and dispensing liquids. The inner surface 108 of the capillary 100 comprises a reasonably hydrophilic surface that draws liquid into the channel by capillary action. The outer surfaces 110, 112, and 114 of the capillary 100 can comprise an appropriately hydrophobic surface to limit the wetting of the exterior surface by liquid within the capillary 100. Wetting of the exterior surfaces 110, 112, and 114 is undesirable since it accelerates the evaporation of a stored liquid by increasing the surface area of the vapor/liquid interface as one can perceive from FIG. 3. On a more basic level, wetting is disadvantageous in that it is likely to render the handling of capillaries 100 in a system challenging due to slippery walls and the possibility of cross-contamination.

A substrate 12 can be made of any solid material such as metal, ceramics, glass, and organic materials including polymers. In principle, capillary dispensing is compatible with any solid substrate 12 regardless of its surface tension and topology as long as dispensing liquid contacts the substrate 12. However, the efficient control of the shape, volume, and size of a droplet 10 requires sophisticated selection of the surface tension and topology of a substrate 12.

The deposition of aqueous solutions containing biological materials such as proteins and cells onto the substrate may need appropriate surface modification to control the adsorption of biological materials. When non-specific adsorption of proteins is undesirable, the surface of the substrate 12 can be modified with a thin film (not shown) such as a silane film terminated with ethylene glycol to minimize adsorption. When dispensing solutions containing cells, the surface of the substrate 12 can include a thin film engineered to enhance the cell adsorption.

An important feature of the present method and system is the aspiration of droplets, such as that shown at 10. Within the context of this disclosure, aspiration can be read to comprise the intake of all or part of a droplet 10 by a dispensing member, such as a capillary 100. An empty capillary 100 can aspirate most of a single droplet 10 simply by capillary action after the capillary 100 has been plunged into the droplet 10. In other words, essentially all of the droplet 10 can be aspired by displacement of the liquid column within the capillary 100.

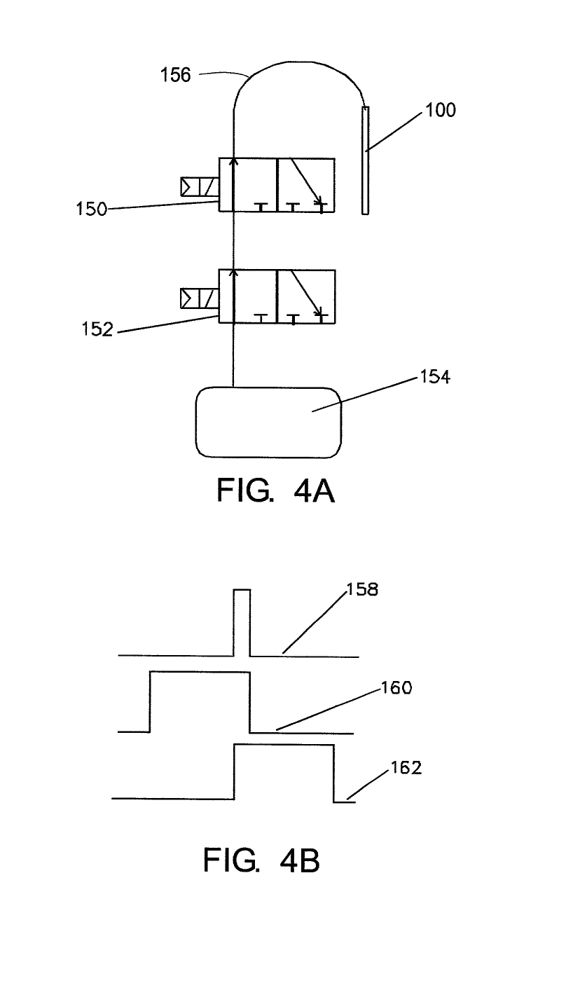

In the dispensing technique described herein, the preferred method for forming the bolus 116 is applying a pressure pulse of air to the distal end 102 of the capillary 100. The pressure pulse can be delivered to the capillary 100 by means of a perfectly sealed or an imperfectly sealed fit to a tube or the like carrying the pressure pulse. In a typical configuration, such as that simplistically shown in FIG. 4A, the pneumatic system includes a high pressure (10 to 150 Psi) air supply 154 that is passed through either one or two stages of regulators to bring the pressure down in a precise manner preferably to between 0.03 and 3 Psi with the precise pressure depending on a number of factors including the design of the capillary 100. The preferred pressure for the capillary 100 described particularly herein is approximately 0.06 Psi. Once the airflow exits the regulator(s), it can be gated by one or more solenoid valves 150 or 152. Ideally, a solenoid valve 150 or 152 with a short response time (typically 3-7 milliseconds) would be used to provide accurate control of the duration for the pressure pulse. The preferred duration of the pressure pulse when using the previously discussed capillary 100 is between 5 and 7 milliseconds.

For the bolus 116 to make contact with the substrate 12, the capillary tip or proximal end 101 must be within a certain distance of the substrate 12. This distance has been identified as one of the most sensitive parameters in the system with respect to determining and adjusting final droplet volume. Depending on the desired volume of droplet 10 and the design of the capillary 100, this height can be varied between several microns and several millimeters. Typically with the aforementioned capillary 100, this distance between the capillary tip 101 and the substrate 12 is between 100 and 1200 microns. This distance can be controlled through a plurality of methods, but is typically controlled with a servo or stepper motor driven lead screw stage or a linear motor (neither of which are shown). The capillary 100, indeed multiple capillaries 100 disposed in rows or other configurations, can be held in either a rigid body that is positioned, or the capillary 100 or capillaries 100 can be positioned within a flexible carrier.

As displayed in FIG. 4A, to provide faster and more accurate pressure pulse duration, two valves 150 and 152, which can be solenoid valves, can be plumbed in series between the capillary 100 and the precisely regulated compressed air supply 154. FIG. 4B shows time dependency of three parameters: the pneumatic pressure 158, the logic signal 160 for the first valve 150, and the logic pulse 162 for the second valve 152. The rising edge of the pressure pulse 158 can be created by opening the first valve 150 then opening the second valve 152. The falling edge of the pulse can be created by shutting the first valve 150 shortly after opening the second valve 152.

In any event, looking again to FIG. 5B, one will again note that bolus 116 can be considered most generally a rounded mass of liquid. When formed at the proximal end 101 of the capillary 100, the bolus 116 preferably is forced out of the dispensing member or capillary 100 in a temporary fashion such that continuity is maintained between the liquid in the inner volume of the capillary 100 and the expelled sub-volume or bolus 116 at all times. The bolus 116 typically has a volume of approximately 300 nanoliters, but the system will tolerate significantly varied bolus volumes, such as between 1 nanoliter and 5 microliters. Bolus formation typically occurs in 50 milliseconds but is dependent on a number of system variables and can range from 10 milisecond up to several minutes. In a preferred embodiment, the bolus formation is controlled by a pressure pulse applied through the modulation of a solenoid valve, such as the first valve 150. The solenoid valve 150 is positioned in a pneumatic system between a precisely regulated pressure source, such as the air supply 154, and a connection to the dispensing member 100. The solenoid valve 150 modulates a pneumatic flow of typically 3 mbar that can range from, for example, 0.5 mbar to 800 mbar based on the design of the dispensing member 100. The solenoid valve 150 is actuated for a typical duration of 5 milliseconds and can range in duration from 1 to 1000 milliseconds.

Alternatively, the bolus 116 could be formed by inertial loading of the column of liquid 222 in the dispensing member 100. Acceleration of the dispensing member 100 in a direction opposing the direction of desired bolus 116 formation could create an inertial load on the liquid sufficient to overcome the forces that maintain the column of liquid 222 entirely inside the dispensing member 100. The magnitude of the acceleration required is dependent upon the system forces involved such as negative back pressures, capillary action, hydraulic flow resistance, gravity, electro-osmotic flow, and electrostatics.

Alternatively, the bolus 116 could be formed through the use of a positive displacement dispensing system. In a positive displacement system, the liquid would be forced out through the reduction of the free interior volume of the dispensing member 100. This reduction in the free interior volume of the dispensing member 100 could be caused by many techniques such as mechanical reduction of the interior volume or thermal expansion of a substance collocated in the interior volume.

Alternatively, the bolus 116 could be formed by gravitational forces acting on the liquid in the dispensing member 100. The formation of the bolus 116 could be controlled through adjusting the orientation of the dispensing member 100 within the gravitational field.

Alternatively, the bolus 116 could be formed using electrostatic forces on charges contained within the liquid in the dispensing member 100. The liquid would be forced out of the dispensing member 100 by exposing the charges contained in the liquid to a controlled electric field.

In any event, forming the bolus requires temporarily overcoming the forces holding the liquid in the dispensing member 100. This can be achieved using a single technique or any combination of the techniques described here.

A portion of the bolus 116 is retracted into the dispensing member 100 leaving the droplet 10 on the surface of the physical substrate 12. The means through which the bolus 116 is retracted into the dispensing member 100 can vary, but the preferred embodiment employs capillary action of the dispensing member 100. This capillary action can be controlled through affecting, among other things, the surface energy of the interior of the dispensing member 100.

Alternatively, the bolus 116 can be retracted by applying a negative pressure, such as a vacuum, to the inner volume of the dispensing member 100. This negative pressure could be created by exposing the interior volume to a partial vacuum source or by expanding the interior volume of a sealed portion of the dispensing member 100. The interior volume could be expanded through mechanical means or through otherwise reducing the volume of an additional substance that is collocated inside a rigid dispensing member 100.

Alternatively, the bolus 116 can be retracted through the use of inertial forces.

In still another alternative, gravitational forces can be used to control bolus 116 retraction through adjusting the orientation of the dispensing member 100 within the gravitational field.

Alternatively, the bolus 116 could be retracted using electrostatic forces on charges contained within the liquid in the dispensing member 100. The liquid would be withdrawn into the dispensing member 100 by exposing the charges contained in the liquid to a controlled electric field.

The retraction of the bolus 116 can be accomplished through, for example, any of the means described here or any combination of those means. Even further, the technique for retracting the bolus 116 can be combined with any of the previously discussed techniques to form the bolus 116 in the dispensing technique claimed herein.

FIGS. 6A-D depict one sequence of events in droplet deposition. FIG. 6A depicts the capillary 100 containing a volume of liquid 218 suspended above the substrate 12 prior to the introduction of an air pulse. FIG. 6B depicts the system immediately after the application of the air pulse where an expanding bolus has formed a bridge 220 between the capillary 100 and the substrate 12 with a column of fluid 222 remaining within the capillary 100. FIG. 6C depicts the system immediately after cessation of the air pulse with the bridge 220 being necked at a neck portion 208 due to the capillary force. FIG. 6D depicts the system at equilibrium with a sessile drop 10 present on the surface 12 with the majority of the fluid that previously formed the bridge 220 retracted within the capillary 100 as the column of fluid 222. The volume of the droplet 10 is dependent upon numerous interfacial forces within the system.

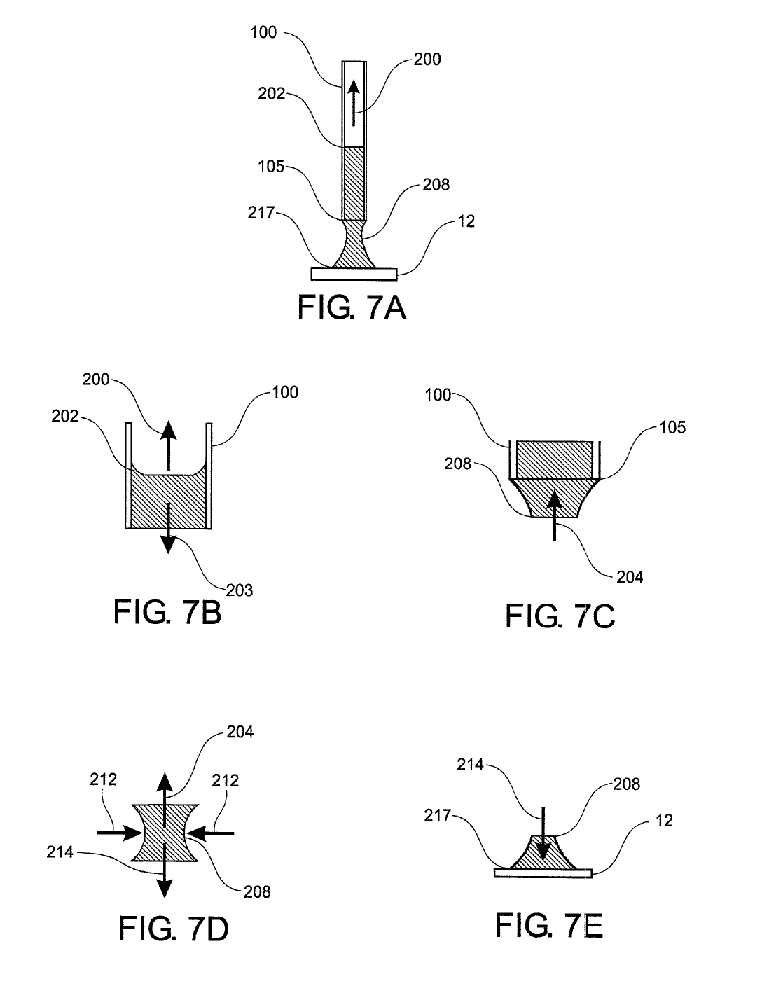

The following analytical model can provide a more complete understanding of the present invention as it can be particularly embodied in a system and method for dispensing and aspirating liquids. The present analysis is conducted at the instantaneous moment in time prior to formation of the droplet 10. Upon cessation of the air pulse, the system experiences four important forces as displayed in FIG. 7A-E. In FIG. 7B, the capillary force 200 draws the liquid upward against the force of gravity 203. In FIG. 7C, the adhesion of the liquid to the face 105 of the capillary 100 constrains the profile of the bridge 220 to an intersection with the outer edge of the capillary wall. In FIG. 7D, the liquid-liquid cohesion 212 creates necking. In FIG. 7E, the liquid adheres to the surface of the substrate 12. These four forces are the dominant factors in determining the volume of a droplet 10.

Mathematically, the four forces can be described as follows. Each force is described as pressure P in force per area, or a surface tension T in force per length.

The capillary rise or driving pressure 200 is described by the Laplace equation of capillarity:

$${P}_{C} = {γ}_{LV} ( \frac{1}{{R}_{1}} + \frac{1}{{R}_{2}} ) - ( {ρ}_{L} - {ρ}_{V} ) g ( z + {z}_{0} )$$

where γₗᵥ,R₁,R₂,ρ_{L},ρ_{V},g,z,z₀ are the surface tension at the liquid-vapor interface 202, the principle radii of curvature of the meniscus, the density of the liquid, the density of the vapor, the force of gravity 203, an arbitrary height reference, and an initial height respectively.

The resistant force 204 due to the adhesion of the liquid to the capillary face 105 shown in FIG. 7C is

T_{CF}=γₗᵥ(1+cos θ₂),

where θ₂ is the contact angle of the liquid at the capillary face 105.

The resistant force due to the liquid-liquid cohesion 212 at the point of necking 208 leading to inward movement of the fluid shown in FIG. 7D is

T_{LC}=2γ_{LV}.

The resistant or adhesive force 214 is due to adhesion of the fluid to the substrate 12. This adhesive force 214 to the substrate 12 as shown in FIG. 7E is mathematically expressed as

T_{SA}=γ_{LV} Sin θ₄,

where θ₄ is the contact angle at the liquid-substrate interface 217.

The description of these forces indicates several modalities for the control of a volume dispensed by the system. Numerous techniques can be used to manipulate these forces for control of the disposition and aspiration of droplets 10.

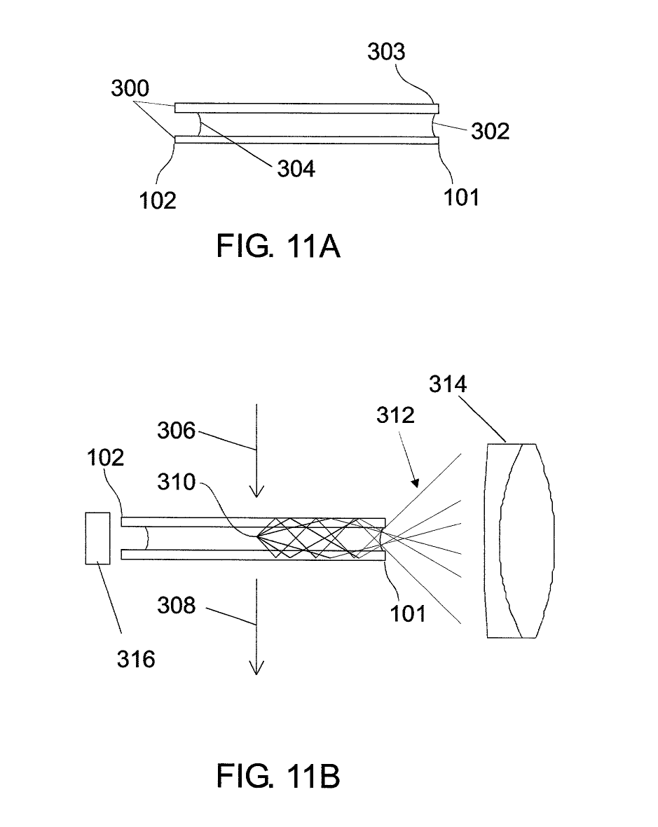

By reference again to, for example, FIGS. 6A-6D, the volume of liquid 218 could comprise an assay retained in the inner channel of the capillary 100. At least two possibilities are available for drawing the assay into the capillary 100. A first method is capillary action, which is driven by surface tension of the assay liquid 218 along the inner surface 108 of the capillary 100. Alternatively, the volume of liquid 218 can be aspirated into the inner channel by withdrawing air from the distal end of the capillary 100 thereby pulling, for example, an assay droplet 10 into the capillary 100 through the proximal end 101 of the capillary 100. Other methods for retracting the assay droplet 10 into the capillary 100 are certainly possible. Preferably, the liquid forms a concave meniscus, such as that shown at 304 in FIG. 11A, within the inner volume of the capillary 100.

A heterogeneous biochemical assay can be performed under the present invention with a specific binding cascade. The process can be initiated by aspiration of the assay droplet 10 into a dispensing member 100. In one embodiment, the dispensing member 100 contains an appropriately specific binding partner immobilized on its inner surface 108. Next, an incubation step of suitable duration for capture of the desired analyte onto the inner surface 108 of the dispensing member 100. Upon achieving substantial completion or at least a significant extent of specific binding of analyte onto the inner surface 108, the analyte-depleted assay droplet 10 may then be expelled from the dispensing member 100.

Subsequently, one or more wash steps may optionally be performed to remove any remaining unbound analyte and/or other potentially interfering species that may be present by performing a suitable number of liquid aspiration/expelling cycles as described above. If necessary or desirable, additional specific binding step, each with or without one or more associated wash steps, to immobilize one or more specifically detectable “reporter” species may be performed. If the specific binding cascade resulted in the immobilization of a directly detectable reporter species (e.g., a fluorophore such as fluorescein or Cy5), then detection of one or more specific signal(s) may be accomplished by a wide variety of detection means known to the art (e.g., fluorescence, luminescence, colorimetric or radiometric methods). Alternatively, if a suitable catalytically active reporter species (e.g., an enzyme such as alkaline phosphatase) has been specifically immobilized, the dispensing member 100 may then be filled with substrate solution, optionally followed by an incubation step of appropriate duration, prior to detection of the product of the enzyme reaction using a wide variety of detection means known to the art as indicated above.

In another embodiment, heterogeneous biochemical assays may be performed by the method of this invention as described above, but instead using a dispensing member 100 lacking any pre-immobilized binding partner species. As discussed herein, the immobilization of the specific binding cascade onto a different solid substrate surface, such as the surface of the substrate 12, than that of the dispensing member is carried out as a separate step, after all other specific binding interactions involved in the given binding cascade have been allowed to occur in homogeneous solution within the dispensing member 100. In this embodiment, the alternate substrate on which an appropriately specific binding partner (capture reagent) has been pre-immobilized may be an assay plate (e.g., 384 or 1536 well microplate), a flat slide (e.g., glass or plastic), a hydrophobically masked slide with a hydrophilic well spot array, or any configuration known to the art.

Alternatively, the liquid can be mixed by rotating the capillary 100 end-over-end. Such rotation involves flipping the capillary 100 end-over-end followed by an appropriate settling time in-between flips. If necessary or desirable, additional specific binding steps, each with or without one or more associated wash steps, to immobilize one or more specifically detectable “reporter” species may be performed. Alternatively, if a suitable reporter species (e.g., an enzyme) has been specifically immobilized, the dispensing member 100 may then be filled with substrate solution prior to detection of one or more specific signal(s) by a wide variety of detection means known to the art (e.g., fluorescence, luminescence, colorimetric or radiometric methods).

One will appreciate that incubation and detection require a carefully controlled environment. The liquid-filled capillary 100 should be housed in a light-tight enclosure with controlled temperature and humidity. Ideally, the liquid-filled capillary 100 will be sealed at both ends 101 and 102 to eliminate not only evaporation but also cross-contamination between capillaries 100. Upon conclusion of the incubation time period, an optical detection can be performed on the assay while it is still enclosed within the capillary 100.

Alternatively, the liquid in the capillary 100 can be expelled from the capillary 100 for several constructive purposes. Firstly, a specific detection method might require a special substrate 12 such as surface plasmon resonance, which requires planar films of specific dimensions on the order of microns. Secondly, the assay can be deposited onto a droplet containing reagent, which stops the biochemical reaction and forms a new assay droplet. Subsequently, the new assay droplet can be withdrawn into the capillary 100 for a plurality of purposes.

In one preferred embodiment as shown in FIG. 3, a capillary 100 with a tapered end is made of glass. The capillary 100 can be employed to dispense liquids, such as DMSO solutions, containing small organic molecules or aqueous solutions containing biological materials such as proteins and cells. In this exemplary embodiment, the ID and OD of the body of the capillary 100 are 0.4-0.7 and 0.95 mm, respectively, and the ID and OD of the nozzle 104 of the capillary 100 are 0.14-0.24 and 0.38-0.48 mm, respectively. The length of the capillary 100 can, for example, be 27 mm. The inside wall 108 of the preferred capillary 100 has a hydrophilic surface, primarily a cleaned bare glass surface. The hydrophilic bare glass surface can be obtained by exposing the capillary 100 to plasma oxidation or an acidic or basic cleaning solution and possibly baking at elevated temperature.

The exterior surfaces 110, 112, and 114 of the capillary 100 can have a hydrophobic surface coated with a silane reagent or polymeric species. The surface tension of the modified exterior surfaces, such as 110 and 112 should be low (18-30 mN/m) enough to avoid the wetting of the cylindrical body exterior 110 and the nozzle exterior 112 of a capillary 100 by, for example, DMSO and aqueous solutions. A thin, hydrophobic film prepared by a silane reagent such as perfluorodecyl trichlorosilane, perfluorooctyl triethoxysilane, octadecyl trichlorosilane, and octadecyl triethoxysilane, shows satisfactory performance of avoiding the wetting by liquids, such as DMSO and aqueous solutions.

In one practice of the invention, a volume of liquid in the range of 1 nl to 100 μl is introduced into the capillary 100 from a microtiter plate (not shown) or other source via capillary action. The capillary 100 is connected to a low pressure air source, such as the air supply 154, capable of delivering a short pulse of air at 0.01-10 psi for an approximate duration of 10 msec. The capillary 100 is brought to within 10-3000 microns of an appropriately hydrophobic substrate 12 having a contact angle ranging from 40 degrees to 120 degrees, preferably, from 60 degrees to 100 degrees. A pressure pulse creates the following sequence: growth of a bolus 116 from the capillary 100, formation of a bridge 220 of liquid between the capillary 100 and the substrate 12, necking of the bridge 220, and finally breaking of the bridge 220. By virtue of the interfacial phenomena at play, a droplet 10 is left on the substrate 12.

The preferred surface tension of the substrate 12 is determined by the surface tension of the dispensing liquid and the volume and shape of the droplet 10 desired. Generally, the surface tension of a substrate 12 is selected to produce droplets 10 showing contact angles 16 in the range of 40-120°, preferably 60-100°. The surface tension and topology of the substrate 12 are two key parameters determining its performance in capillary dispensing.

In this application, examples of dispensing dimethylsulfoxide (DMSO) and aqueous solutions onto a glass substrate 12 are provided. The surface tension of DMSO is 43.5 mN/m, and the appropriate surface tension of the substrate 12 is 18-35 mN/m. For example, a glass substrate 12 with a surface tension of more than 60 mN/m can be modified with a silane reagent such as perfluorodecyl trichlorosilane or triethoxysilane or octadecyltrichlorosilane or triethoxysilane. A thin silane film formed by these reagents produces a substrate 12 with a surface tension of 18-30 mN/m. When aqueous solutions are dispensed, a substrate 12 with a lower surface tension, for example, 25-55 mN/m, is preferred due to higher surface tension of water (72.5 mN/m). However, since the surface tension of aqueous solutions varies with solutes dissolved in, the surface tension of the substrate 12 is tailored appropriately to obtain the contact angles between 60-100°.

The volume dispensed by the capillary 100 is determined by a number of parameters such as the ID and OD of the nozzle 104, the amount of liquid in the capillary 100, the pressure of the air pulse, the angle of tip face 105 or 106, the distance of the capillary 100 from the substrate 12, and the surface tension of the liquid, the interior and exterior of the capillary 100, and the substrate 12. Among these parameters, the distance of the capillary 100 from the substrate 12, the angle of the tip face 105 or 106, and the surface tension of the solid substrate 12 and the interior of the capillary 100 are important variables that decide the size of a resulting droplet 10. The volume of the dispensed droplet 10 can be modulated by controlling these parameters.

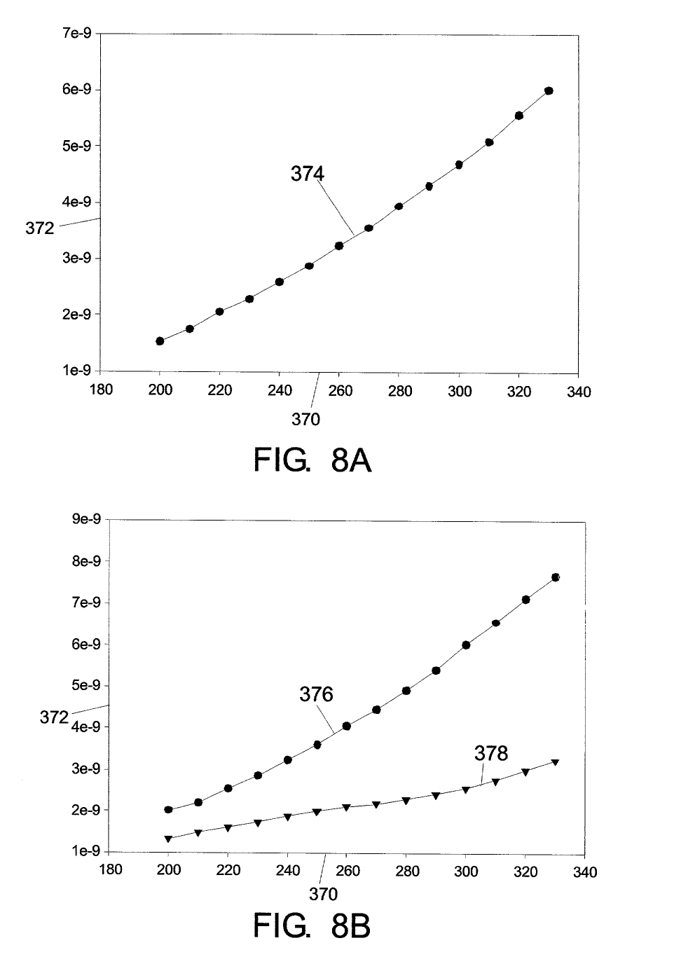

The dispensing volume can be modulated by varying the distance between the substrate 12 and the capillary 100. The distance is by far the most important factor among those parameters deciding the volume of the dispensed droplet 10. FIG. 8A displays a graph describing the typical variation of volume dispensed with increasing the distance between the capillary 100 and the substrate 12. The abscissa 370 represents the capillary-substrate distance in microns. The ordinate 372 represents the droplet volume in liters. The first curve 374 is experimental data with individual data points represented by solid circles. In the graph, the volume ranges from 1.5-7 nL at 200-330 μm height. In this test, a capillary 100 with body OD and ID of 0.95 and 0.7 mm, respectively, and nozzle 104 OD and ID of 0.48 and 0.24 mm, respectively, was employed for dispensing onto a glass slide coated with a hydrophobic octadecyl silane film with a surface tension of about 22 mN/m.

Part of the novelty of this process is that it is completely reversible through dispensing and aspiration, and the size of the droplet 10 can be adjusted by moving the capillary 100 with respect to the substrate 12. Such substantial dependence of the dispensed volume on the capillary-to-substrate distance results from variation of the neck-breaking point with changing distance. The capillary 100 is capable of depositing and aspirating any amount of liquid in the sub-microliter range. The dispensing volume can be modulated by varying, among other things, the surface tension of the capillary 100. Typically, for a given capillary 100, the variation of dispensed volume based on different surface tensions of the exterior 110, 112, and 114 of the capillary 100 is less than 20%. In contrast, the surface tension of the inner surface 108 exhibits a dramatic effect on the volume of the dispensed droplets 10. The significant effect of the characteristics of the inner surface 108 derive from their dominant role in deciding capillary force.

The dispensing volume can be modulated by employing a variety of geometries in the design of the capillary tip 101. Two examples of tip geometry are displayed in FIGS. 2D and 2E: flat 104 or angled face 106. Capillaries 100 with angled faces 106 tend to generate smaller droplets 10 than those with flat faces 104. By varying the angle of the tip face 104 or 106, the dispensing volume can be modulated. This results from a different geometry of the bolus 116 due to the different area and position of the liquid/capillary interface. The angled tip face 106 produces a bolus 116 whose liquid/capillary interface is not parallel with the substrate 12 and exposes a larger interfacial area. Such variation in the liquid/capillary interface seems to produce droplets 10 of lesser volumes for a given capillary 100.

Even further, it should be noted that the liquid-surface adhesion can be modified by altering the free surface energy of the substrate through application appropriate coatings. Such modifications yields a different range of volumes dispensed. FIG. 8B depicts the effect of surface tension on capillary dispensing, where two glass substrates 12 coated with an octadecyl silane film exhibiting surface tension of ˜21 and ˜28 mN/m were tested. The abscissa 370 represents the capillary-substrate distance in microns. The ordinate 372 represents the droplet volume in liters. A plot 376 for the substrate 12 of lower surface tension displays larger droplet volume than the plot 378 for the substrate 12 of higher surface tension. This is so because the lower surface tension presents stronger attraction toward a bolus 116 and, therefore, retains more liquid on its surface upon neck-breaking. In general, a substrate 116 of lower surface tension exhibits greater retention of liquid as expected from the point of interfacial interaction. Such dependence of dispensing volume on the surface of the substrate 12 can be employed to adjust the volume as needed.

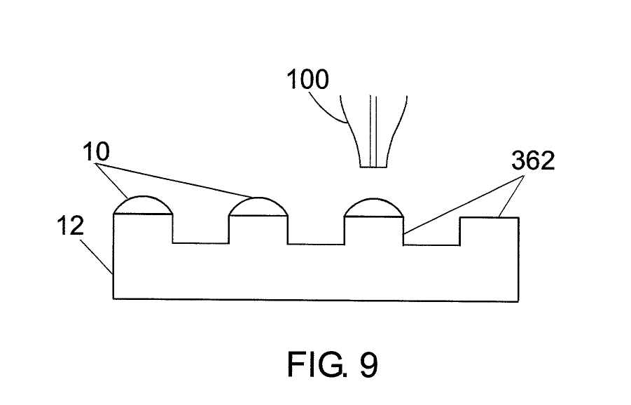

Additionally, the dispensing volume can be modulated by employing a substrate surface of different topology. An example of surface topology is provided in FIG. 9, which displays a surface with cylindrical columns 362 with flat tops. The cylindrical columns 362 confine the contact between dispensing liquid and the surface within a specified area on the surface. When the bolus 116 from the dispensing member 100 contacts the substrate 12, the bolus 116 contacts only the top of a column 362, and the diameter of the droplets 10 formed is same as that of the column 362. The contact of the bolus 116 with the substrate 12 surface is limited within a designated area and, therefore, produces droplets 10 which occupy only the predetermined area. For applications needing droplets 10 of constant volume, such fixation of drop diameter is expected to improve the speed and accuracy of dispensing significantly.

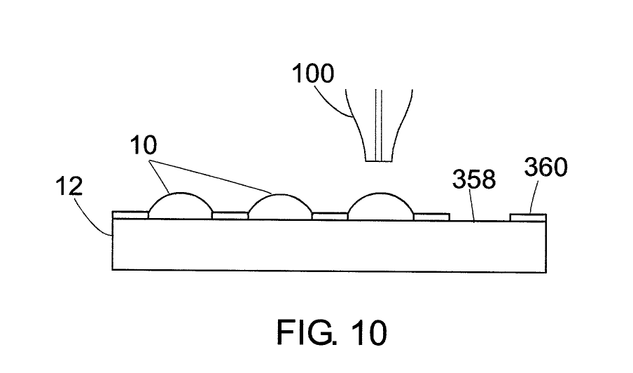

Even further, the present inventors have discovered that the dispensing volume can be modulated by introducing patterns of different surface tension to a design of a substrate surface. An example of surface patterning is provided wherein a homogeneous surface or a surface exposing hydrophilic wells 358 surrounded by relatively hydrophobic areas 360 is shown in FIG. 10. The presence of the hydrophobic areas 360 next to the hydrophilic wells 358 confines the spreading of the bolus 116 to within the wells 358 during dispensing and, thereby, produces droplets 10 whose diameter is the same as that of the hydrophobic wells 358. This approach is similar in principle to the surface exposing cylindrical columns 362, which limits the contact of the dispensing liquid with a particular surface.

Advantageously, in certain embodiments, the dispensing member, such as the capillary 100, can be employed to act as an incubation chamber. As one knowledgeable in the art will be aware, an assay is a biochemical reaction created by a mixture of reagents to test the activity and specificity of enzymes and drugs. An assay can also measure the residual activity and kinetics of those enzymes and drugs in the presence of an inhibitor. Assays are extremely important in high throughput screening of potential drug compounds.

On average, present day assays are 1 uL or greater in volume. A further reduction is desired for reducing the cost of the consumed materials. More important than volume is the actual amount of precious compounds in limited supply. An example of such a precious compound is expression of a protein from a single piece of DNA. The present invention reduces the volume of an assay to below the current standard of 1 uL.

Retraction of a droplet into a capillary 100 provides a vessel for such important assays in small volumes. Furthermore, the temperature and evaporation of the assay can be easily controlled within the capillary 100. Numerous assays require extended lengths of time, during which evaporation becomes very difficult to control at sub uL volumes especially in an open environment. Advantageously, the transparent features of the capillary 100 permit numerous optical methods of measurement of chemical activity.

A capillary 100 filled with liquid can act constructively as a light-pipe. A light-pipe confines traveling light by means of total internal reflection at the outside wall of the capillary. Consequently, the light-pipe transfers light longitudinally over long distances while containing the light within the same transverse area.

As previously described, the capillary 100 can hold liquid during incubation and detection as displayed in FIG. 11A. In FIG. 11A, a liquid-filled capillary 100 is displayed. The capillary walls 300 of the body portion 303 define a channel in which the liquid is held. The liquid forms two menisci 302 and 304 within the channel. The first meniscus 302 is nominally located at the proximal end 101 of the capillary 100. The second meniscus 304 occurs within the channel. In FIG. 11B, a fluorescent process is displayed. Excitation light 306 travels transversely with respect to the axis of the capillary 100. A large portion of the resulting fluorescent emission 310 is confined transversely by the light-pipe. The confined fluorescence 310 travels towards the proximal end 101 of the capillary 100 where it exits the light pipe while non-confined excitation light 308 passes through the capillary 100. The exiting fluorescent light 312 is collected by a lens 314 and directed to a detector (not shown).

The capillary 100 can also be exited with light entering from either end. In this situation, the excitation light also experiences confinement by the light pipe. This situation creates uniform and efficient excitation. However, any back reflected light can potentially reach the detector where it must be rejected by a spectrally selective filter.

The capillary 100 can be made arbitrarily long while maintaining the same exit aperture. The strength of the fluorescent light 312 signal is proportional to the volume of the liquid. Thus, as the length of the liquid volume grows, the strength of the exiting fluorescent light 312 also grows while the space-and-angle occupied by the exiting fluorescent light 312 remains constant. The space-angle distribution is extremely important to the optical system, which collects light over a specific field stop that defines the space of collection and a lens aperture that defines an angle of collection. As the capillary 100 grows, the volume of excitation within the light pipe increases while the space-angle distribution at the collection optics remains static. Consequently, the amount of fluorescent light 312 emerging from the light grows while its space-angle distribution remains constant.

Fluorescent light 312 is also contained while traveling away from the proximal end 101 of the capillary 100. This light can be redirected towards the proximal end 101 by placing a reflector 316 at the distal end 102. The reflector 316 can be a mirror or preferably a retro reflecting film that reflects the light along its incident path.

The inner surface of the capillary 100 should be able to accommodate molecules dissolved in liquid by either enhancing or avoiding their adsorption to the surface of the substrate 12. This is particularly critical in storing solutions with biological materials, such as proteins and cells in a capillary 100. The inner surface can be modified with a thin organic film to tailor its surface properties accordingly. For example, the presence of a thin film terminated with ethylene glycol on an interior surface minimizes the non-specific adsorption of biomolecules.

The inner volume for the incubation capillary 100 should be long and narrow. There are two important benefits to this aspect ratio. First, this aspect ratio minimizes evaporation by reducing the area of the liquid-vapor interface. Second, it decreases the length of the empty volume of the capillary 100, which can scatter light out of the lightpipe.

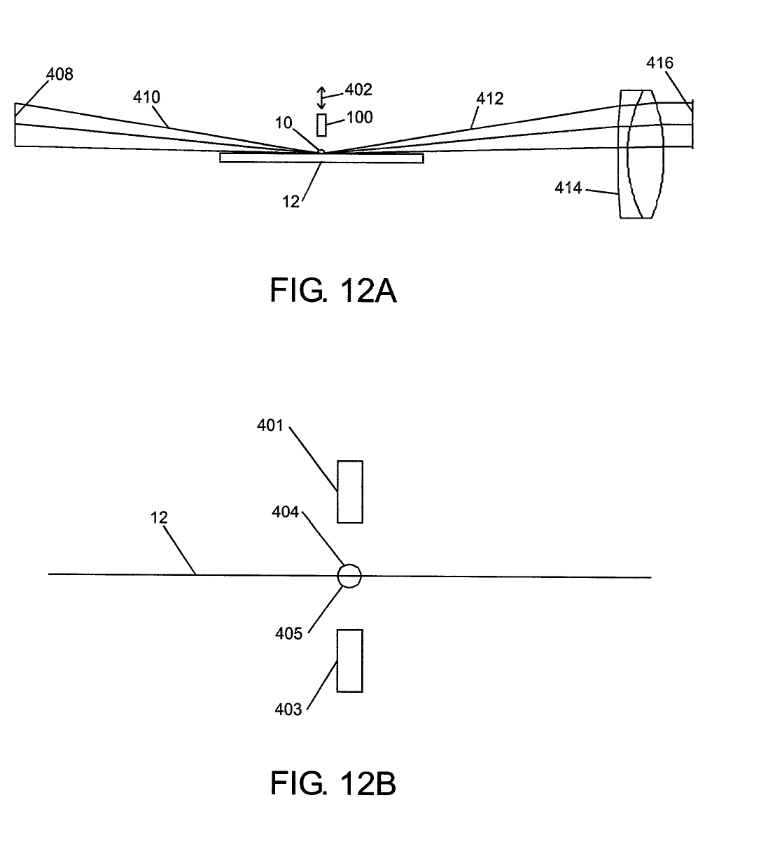

As discussed above, the volume of the deposited droplet 10 is strongly dependent upon the elevation of the capillary 100 above the substrate 12 during the pressure pulse. This parameter of elevation can be repeatedly adjusted in response to measurement of the volume of the deposited droplet 10. Two preferred methods for measurement of the volume are described. A first method for volume measurement employs a transverse imaging system as displayed in FIG. 12A. FIG. 12A is as a view of the transverse vision system, and FIG. 12B is view of the image.

In FIG. 12A, the capillary 100 is translated along its axis 402. The deposited droplet 10 rests atop the substrate 12. A diffuse light source 408 provides backlighting 410 for the droplet 10. Typically, the backlighting 410 is reflected by the substrate 12. Consequently, the exiting light 412 from the droplet 10 is traveling upward from the substrate 12. The exiting light 412 is collected by an objective lens 414. The lens 414 has a collection aperture 416 centered above the substrate 12 while its optical axis is nominally located within the surface of the substrate 12.

There are two important orientations of the lens 414. First, its focal point must be coincident with the axis 402 of the capillary 100. This insures optimal focus of the droplet 10. Second, the optical axis of the lens 414 should be perpendicular to the axis of the capillary 100. This ensures consistent focus along the edges for the capillary 100.

An image created by the transverse imaging system is shown in FIG. 12B. This image contains not only a first image 401 of the capillary 100 and a first image 404 of the droplet 10 but also a mirror image 403 of the capillary 100 and a mirror image 405 of the droplet 10. The edge of the substrate 12 is barely visible as a seam between the images 404 and 405 of the droplet 10. The separation of the capillary images 401 and 403 can be used to measure the elevation of the capillary 100 prior to the deposition. This is important for positioning the capillary 100 within an acceptable range for the initial deposition.

The volume of the droplet 10 is derived from its transverse profile. The droplet 10 is assumed to have a planar base and a spherical cap. By assuming a spherical profile for the droplet 10, only two parameters of the image are necessary for calculation of the volume. The two parameters employed in this embodiment of the transverse vision system are the radius of the transverse profile and the height of the transverse profile. The volume is easily calculated from these two parameters.

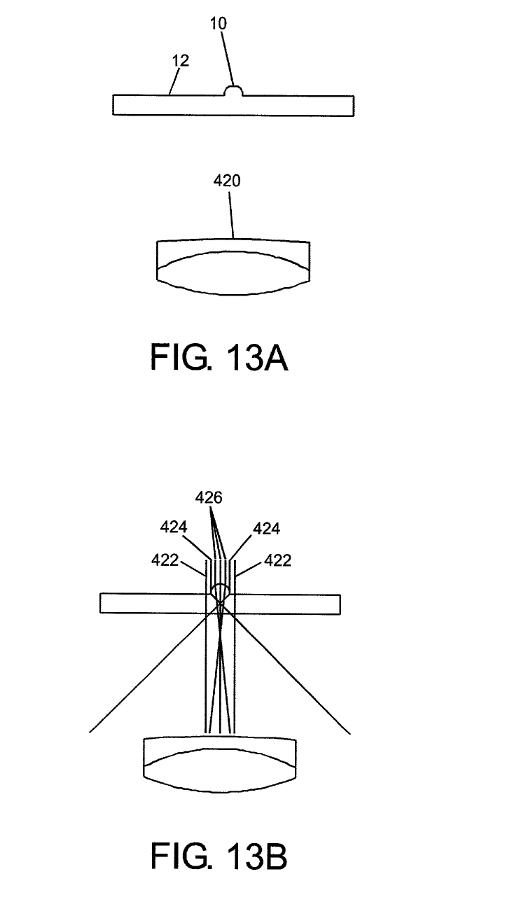

A normal vision system can also be employed to derive the volume of the droplet 10 with a known contact angle. Such a normal vision system is displayed in FIG. 13A where the basic elements are displayed without lighting. The droplet 10 rests atop the substrate 12. A lens 420 is oriented at normal to the substrate 12 and beneath the substrate 12. In FIG. 13B, the rays of light from a directional backlight are added. The directional backlight delivers rays at nearly normal to the substrate 12. The rays at the outside 422 of the droplet 10 are collected by the lens 420 and relayed to the eventual image. The rays at the edge 424 of the droplet 10 are strongly refracted by the droplet 10 and do not enter the lens 420. Consequently, the edge 424 of the droplet 10 is extremely dark in the image. The incident rays at the center 426 of the drop 10 are also refracted but not enough to prevent collection by the lens 420. Thus, the center 426 of the droplet 10 appears as a bright disc. The complete image is a dark ring upon a bright background. The outer edge of the ring has both sharp focus and high contrast, which are important features for edge detection. Therefore, the outer edge of the dark ring provides an excellent measure of the base diameter of the droplet 10. This diameter can be employed with the contact angle to derive the volume.

As such, either vision system can be employed as a means for determining the volume of a dispensed droplet 10. Of course, one skilled in the art would be aware of and, indeed, could conceive of numerous other means for determining the volume of a dispensed droplet 10, and, except as otherwise specified, all such means are within the scope of the present invention. In any event, with such a means for determining the actual volume of a dispensed droplet 10, the system and method of the present invention can compare that actual volume of the droplet 10 to a desired volume of the droplet 10, and any variation between the two can be quantified. If the actual volume differs from the desired volume by more than a given variation, whether that variation is expressed as a percentage or as an absolute volume difference, the system advantageously can adjust the volume of the droplet 10 until an acceptable variation is achieved. As a result, the present system can yield coefficients of variation (CV's) that are markedly improved over the prior art. For example, the system can be set to yield CV's of 1% and possibly better.

Under the present invention, where the actual volume varies from the desired volume by more than the predetermined amount, the actual volume of the dispensed droplet 10 can be adjusted once or multiple times if necessary to achieve an acceptable variation by forming a second bridge of liquid 220 between the dispensing member 100, adding to or subtracting from the droplet 10 as necessary, and then breaking the bridge of liquid 220 thereby leaving a droplet 10 of a different volume than the initial droplet 10. Where the volume of the initial droplet 10 was too low, liquid can be added, and, where the volume of the initial droplet 10 was too high, liquid can be subtracted.

The second bridge of liquid 220 can be formed in at least two ways. First, the proximal end 101 of the dispensing member 100 could simply be plunged into the initial droplet 10. Alternatively, a new bolus 116 could be formed relative to the distal end 101 of the dispensing member 100 and that bolus 116 could be caused to contact the initial droplet 10. If the volume of the initial droplet 10 is to be reduced, a volume of liquid greater than the volume of the bolus 116 can be retracted into the capillary 100. If the volume of the initial droplet 10 is to be increased, a volume of liquid lesser than the volume of the bolus 116 can be retracted into the capillary 100. As the plots of FIGS. 8A and 8B make clear, the height of the proximal end 101 of the capillary 100 is a major factor in determining the dispensed volume of the droplet 10. As such, a manipulation of that height can be employed under the present invention to achieve readily controllable droplet volumes and adjustments to droplet volumes. With this, the system and method provide a closed-loop feedback and control system that can operate in real time for leaving deposited droplets 10 of consistently accurate and controllable volumes.

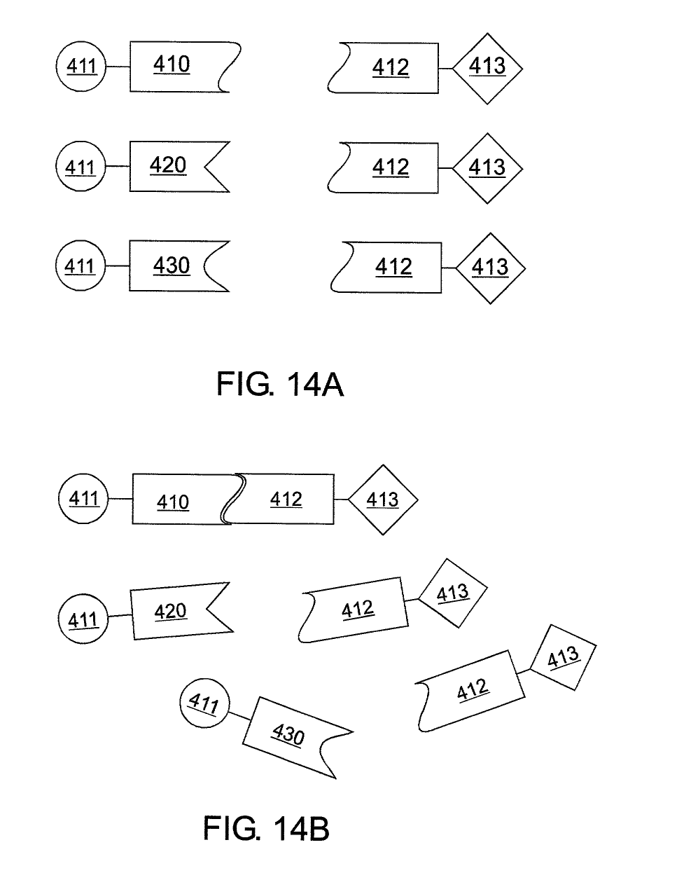

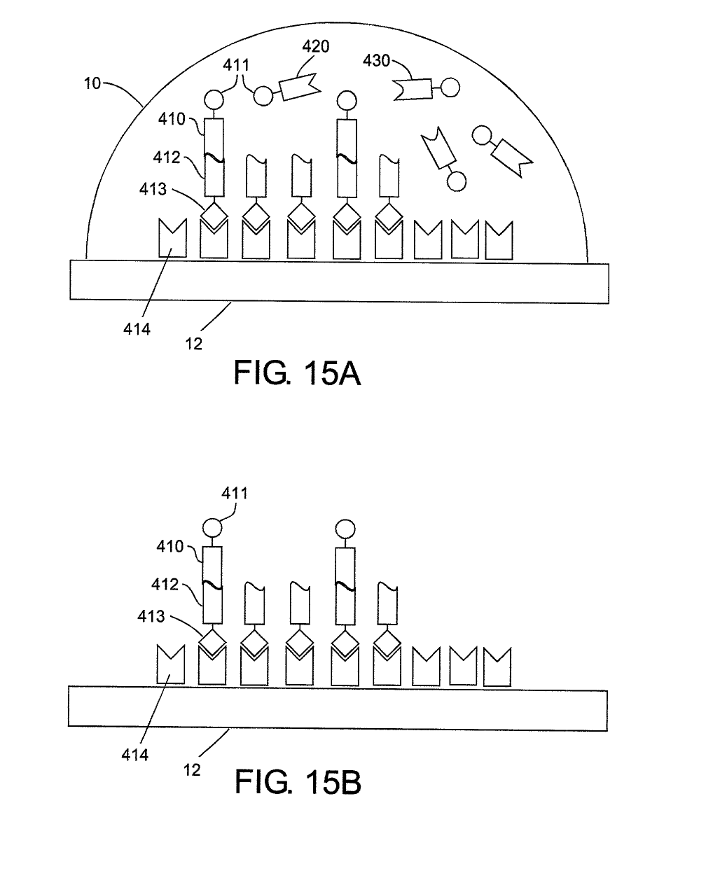

In even further embodiments, some or all of an incubated assay solution in a capillary 100 can be dispensed onto a substrate 12, and the substrate 12 can be used as a filter to selectively immobilize specific molecules among a variety of molecules in the dispensed solution. The substrate 12, now with specific molecules immobilized on its surface, can be washed to remove the unbound molecules and read for detection in the presence of the bound molecules. A better understanding of this practice of the invention can be had by reference to FIGS. 14A, 14B, 15A, and 15B. The first example of FIGS. 14A and 14B focuses on the application of the invention in the area of proteomics, which is the functional analysis of multiple proteins. A sample solution contains three different proteins 410, 420, and 430, each labeled with, for example, a fluorescent marker 411. The solution containing three proteins 410, 420, and 430 is incubated with an antibody 412 that binds specifically with the first protein 410 but not the second or third protein 420 or 430. The antibody 412 carries a tag 413 that also contains specific binding characteristics.

As shown in FIG. 15A, the incubated solution, which comprises at least the antibody 412 and the complex of the antibody 412 and the first protein 410, is dispensed according to the present invention onto the physical substrate 12 within a droplet 10. Before the dispensing occurs, the surface of the substrate 12 is modified with a film exposing an immobilizer 414. The immobilizer 414 is designed to bind to the tag 413 specifically. For example, the tag 413 and the immobilizer 414 can be the residue of hexameric histidine and a nickel-coated surface or biotin and streptavidine, respectively. In the droplet 10 on the substrate 12, the antibody 412 and the complex of the antibody 412 and the first protein 410 bind to the substrate 12 surface via specific attraction or covalent linkage between the tag 413 and the immobilizer 414. In contrast, the other fluorescently labeled proteins 420 and 430 remain unbound. With vigorous washing of the physical substrate 12, only bound molecules of the antibody 412 and the complex of the antibody 412 and the protein 410 remain on the substrate 12 as is shown in FIG. 15B. With this, the substrate 12 with bound molecules 412 and 410 carrying a fluorescent marker 411 can be examined for fluorescent signals.

Advantageously, this approach allows the presence of an unlimited number of proteins in an incubation solution as far as an antibody carries a specific binding character against a specific protein. Furthermore, this approach can be easily applied to the parallel processing of different incubation reactions. A number of incubation reactions can be performed in each capillary 100 and dispensed to specific locations on the surface of the substrate 12 to produce the same format as microarrays of DNA and proteins. A spot on a substrate 12 resulting from each assay can be read and analyzed in the same way as the microarrays.

The proposed approach overcomes significant limitations of conventional methods, particularly the format of a microarray, available for proteomics. Most significantly, the incubation of proteins with ligands such as an antibody occurs in solution, not on the surface of a solid substrate 12. This decreases the probability of proteins becoming denatured substantially and guarantees a complete freedom of proteins and ligands without any structural and steric hindrance. Just as importantly, neither proteins nor ligands exist in dry state during the process, particularly before incubation. Drying proteins and peptide-based ligands, which occurs frequently in the method of microarrays, tends to denature the molecules often causing the loss of their desirable activity.

A second example is focused on biochemical enzyme assay. As an example, a kinase enzyme reaction is described symbolically as

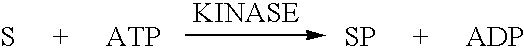

in which: S is a chemical substrate, ATP is adenosine triphosphate, KINASE is an enzyme driving a reaction of phosphorylation, SP is a phosphorylated substrate, and ADP is adenosine diphosphate. A preferred embodiment of such a kinase assay for this invention is

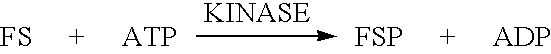

in which FS is a fluorophore-chemical substrate complex and FSP phosphorylated fluorophore-chemical substrate complex. A subsequent spontaneous reaction in this preferred embodiment is

FSP+AbT→FSPAbT

in which AbT is an antibody with a tag for selective binding to an immobilizer on the surface of the physical substrate 12 and FSPAbT a complex of phosphorylated fluorophore-chemical substrate and antibody with a tag. Upon completion of the incubation, the assay solution comprises at least FSPAbT and unreacted AbT along with other species. The solution is dispensed onto the physical substrate 12 whose surface is functionalized with an immobilizer. Among molecules present in a droplet 10 of the dispensed assay solution, only AbT and FSPAbT binds to the surface of the physical substrate 12 via the specific attraction or covalent linkage between the tag in the complex and the immobilizer on the substrate 12. After washing the surface of the physical substrate 12, unbound molecules are removed, and only those bound remain. The physical substrate 12 is read, for example, using a conventional fluorimeter. The absolute amount and ratio of AbT and FSPAbT are expected to allow the quantitative analysis of the activity of the kinase enzyme.

The example of this preferred embodiment can provide a higher signal-to-noise ratio than conventional homogeneous assays employing, for example, fluorescence resonance energy transfer (FRET) and fluorescence polarization (FP) for detection. This advantage can be attributed to the immobilization of products or product complexes relative to the physical substrate 12 and the washing away of unbound molecules that otherwise could generate significant background signals. Furthermore, the design of an assay employing the proposed invention can be more simple and straightforward than a conventional homogeneous assay. Such convenience in the assay design is mainly due to the step of filtering-out, which leaves only the molecules of interest on the physical substrate 12 for detection.

This aspect of the invention offers several significant advantages over conventional filtering-based assays. First, assays in capillaries 100 allow a miniaturization of the volume scale while avoiding evaporation issues. Second, the spotting of each assay from each capillary 100 onto, for example, a flat physical substrate 12 enables simple and straightforward parallel washing and analysis of multiple assays using available systems developed for the field of microarrays.

With a plurality of preferred embodiments of the invention disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein.

Accordingly, it will be clear that those with major features of the invention in mind could craft embodiments that incorporate those major features while not incorporating all of the features included in the preferred embodiments. Therefore, the following claims are intended to define the scope of protection to be afforded the inventors. Those claims shall be deemed to include equivalent constructions insofar as they do not depart from the spirit and scope of the invention.

It must be further noted that a plurality of the following claims express certain elements as means for performing a specific function, at times without the recital of structure or material. As the law demands, these claims shall be construed to cover not only the corresponding structure and material expressly described in this specification but also equivalents thereof.

We claim as deserving the protection of Letters Patent:

1. A method for depositing a volume of fluid relative to a surface to produce a droplet relative to the surface, the dispensing method comprising the steps of:
providing a dispensing member;
providing a means for forming a bolus of liquid relative to the dispensing member;
providing a means for retracting at least a portion of the bolus of liquid;
providing a surface for receiving the droplet;
forming a bolus of liquid relative to the dispensing member;
causing the bolus of liquid formed relative to the dispensing member to make contact with the surface thereby forming a bridge of liquid between the dispensing member and the surface; and
retracting only a portion of the bolus of liquid to break the bridge of liquid between the dispensing member and the surface thereby depositing a droplet on the surface.

2. The dispensing method of claim 1 wherein the step of causing the bolus of liquid to make contact with the surface is performed by growing the bolus of liquid.

3. The dispensing method of claim 2 wherein the step of growing the bolus of liquid is performed with the dispensing member disposed a given, fixed distance from the surface.

4. The dispensing method of claim 1 further comprising the step of providing a pre-existing droplet on the surface and wherein the droplet is deposited relative to the pre-existing droplet.

5. The dispensing method of claim 1 wherein the step of causing the bolus of liquid formed relative to the dispensing member to make contact with the surface includes moving the dispensing member and a location on the surface into proximity with one another.

6. The dispensing method of claim 5 wherein the step of moving the dispensing member and the location on the surface into proximity with one another comprises moving the dispensing member toward the location on the surface.

7. The dispensing method of claim 5 wherein the step of moving the dispensing member the location on the surface into proximity with one another comprises moving the location on the surface toward the dispensing member.

8. The dispensing method of claim 5 wherein the step of forming the bolus of liquid relative to the dispensing member happens after the step of moving the dispensing member and the location on the surface into proximity with one another.

9. The dispensing method of claim 5 wherein the step of forming the bolus of liquid relative to the dispensing member happens before the step of moving the dispensing member and the location on the surface into the proximity with one another.

10. The dispensing method of claim 5 wherein the step of moving the dispensing member and the location on the surface into proximity with one another is not sufficient to cause the dispensing member to make contact with the surface once the bolus is formed.

11. The dispensing method of claim 1 wherein the step of providing the dispensing member comprises providing a dispensing member with an inner volume for retaining a volume of liquid and an orifice for allowing the passage of liquid therethrough.

12. The dispensing method of claim 11 wherein the step of providing the dispensing member comprises providing a dispensing member with an open proximal end for being disposed in proximity with the surface, an open distal end, and a channel between the proximal end and the distal end wherein the channel comprises the inner volume of the dispensing member.

13. The dispensing method of claim 12 wherein the step of providing the dispensing member comprises providing a capillary tube whereby the step of providing the means for retracting at least a portion of the bolus of liquid is performed at least partially by capillary forces exhibited by the capillary tube.

14. The dispensing method of claim 13 further comprising forming a second bridge of liquid between the proximal end of the capillary tube and the droplet on the surface and drawing at least a portion of the droplet into the inner volume of the capillary tube.

15. The dispensing method of claim 13 wherein the step of providing the means for retracting at least a portion of the bolus of liquid further comprises applying a lowered pressure to the capillary tube.

16. The dispensing method of claim 13 wherein the step of forming the bolus of liquid relative to the dispensing member comprises disposing a volume of liquid in the inner volume of the capillary tube and at least partially overcoming the capillary forces exhibited by the capillary tube to form the bolus of liquid at the proximal end of the capillary tube.

17. The dispensing method of claim 16 further comprising the step of adjusting a volume of the droplet by forming a second bridge of liquid between the proximal end of the capillary tube and the surface and breaking the second bridge of liquid.

18. The dispensing method of claim 17 wherein the step of forming the second bridge between the proximal end of the capillary tube and the surface comprises forming a second bolus of liquid relative to the proximal end of the capillary tube and causing the second bolus of liquid to contact the droplet.

19. The dispensing method of claim 17 wherein the step of forming the second bridge between the proximal end of the capillary tube and the surface comprises contacting the proximal end of the capillary tube with the droplet.

20. The dispensing method of claim 18 further comprising drawing a volume of liquid greater than a volume of the second bolus into the inner volume of the capillary tube and breaking the second bridge of liquid thereby reducing the volume of the droplet.

21. The dispensing method of claim 18 further comprising retracting a volume of liquid less than a volume of the second bolus into the inner volume of the capillary tube thereby increasing the volume of the droplet.

22. The dispensing method of claim 16 wherein the step of at least partially overcoming the capillary forces exhibited by the capillary tube is carried out by providing an increased pressure within the inner volume of the capillary tube.

23. The dispensing method of claim 22 wherein the step of providing an increased pressure within the inner volume of the capillary tube comprises providing an increased pressure of between approximately 0.01 and 10.0 Psi.

24. The dispensing method of claim 23 wherein the step of providing an increased pressure within the inner volume of the capillary tube comprises providing an increased pressure of approximately 0.06 Psi.

25. The dispensing method of claim 22 wherein the step of providing an increased pressure within the inner volume of the capillary tube comprises providing a pressure pulse of a given duration in the inner volume of the capillary tube.

26. The dispensing method of claim 25 wherein the step of providing a pressure pulse of a given duration comprises providing a pressure pulse of between 1 and 1000 milliseconds.

27. The dispensing method of claim 26 wherein the step of providing a pressure pulse of a given duration comprises providing a pressure pulse of between 3 and 15 milliseconds.

28. The dispensing method of claim 27 wherein the step of providing the capillary tube comprises providing a capillary tube with a body portion of an inside diameter between 0.4-0.7 mm and a nozzle with an inside diameter of between 0.02 and 0.24 mm.

29. The dispensing method of claim 25 wherein the step of providing a pressure pulse is carried out with the proximal end of the capillary tube disposed between 10 and 3000 microns from the surface.

30. The dispensing method of claim 25 wherein the step of providing a pressure pulse is carried out by opening a first valve, then opening a second valve, then closing the first valve wherein the first and second valves are plumbed in series.

31. The dispensing method of claim 22 wherein the step of providing an increased pressure within the inner volume of the capillary tube comprises increasing a pressure in a second fluid that is disposed in the inner volume of the capillary tube with the volume of liquid.

32. The dispensing method of claim 16 wherein the step of disposing the volume of liquid in the inner volume of the capillary tube comprises dipping the capillary tube into a source body of liquid and drawing the volume of liquid into the inner volume of the capillary tube at least partially by capillary action whereby the volume of liquid will tend to be maintained within the inner volume of the capillary tube at least partially by capillary action.

33. The dispensing method of claim 16 wherein the step of at least partially overcoming the capillary forces exhibited by the capillary tube to induce the bolus of liquid to form at the proximal end of the capillary tube comprises forming the bolus of liquid without inducing the bolus of liquid to drop from the capillary tube and without inducing a flow of the volume of liquid from the inner volume of the capillary tube.

34. The dispensing method of claim 1 further comprising the steps detecting the actual volume of the droplet and comparing the actual volume of the droplet to a desired volume of the droplet to determine any variation between the actual volume and the desired volume.

35. The dispensing method of claim 34 further comprising the step of adjusting the volume of the droplet when the variation between the actual volume and the desired volume exceeds a predetermined variation whereby the dispensing method provides a closed-loop feedback and control system that can deposit droplets of consistently accurate and controllable volumes.

36. The dispensing method of claim 35 wherein the step of adjusting the volume of the droplet comprises forming a second bridge of liquid between the dispensing member and the surface and breaking the second bridge of liquid.

37. The dispensing method of claim 36 wherein the step of forming the second bridge between the proximal end of the capillary tube and the surface comprises forming a second bolus of liquid relative to the proximal end of the capillary tube and causing the second bolus of liquid to contact the droplet.

38. The dispensing method of claim 36 wherein the step of forming the second bridge between the proximal end of the capillary tube and the surface comprises contacting the proximal end of the capillary tube with the droplet.

39. The dispensing method of claim 37 further comprising drawing a volume of liquid greater than a volume of the second bolus into the inner volume of the capillary tube and breaking the second bridge of liquid thereby reducing the volume of the droplet.

40. The dispensing method of claim 37 further comprising retracting a volume of liquid less than a volume of the second bolus into the inner volume of the capillary tube thereby increasing the volume of the droplet.

41. The dispensing method of claim 35 wherein the step of detecting the actual volume of the droplet comprises providing a transverse imaging system.

42. The dispensing method of claim 35 wherein the step of detecting the actual volume of the droplet comprises providing a normal imaging system.

43. The dispensing method of claim 12 wherein the step of providing the dispensing member further comprises providing a dispensing member with a coating applied at least to the proximal end of the dispensing member for altering the surface tension thereof and thereby affecting the volume of the droplet deposited on the surface.

44. The dispensing method of claim 13 wherein the step of providing the dispensing member further comprises providing a dispensing member with a coating applied at least to the channel for altering the surface tension thereof and thereby affecting the capillary forces at work.

45. The dispensing method of claim 43 wherein the step of providing the dispensing member with a coating applied at least to the proximal end of the dispensing member comprises providing the dispensing member with a hydrophobic coating applied at least to the proximal end of the dispensing member.

46. The dispensing method of claim 1 wherein the step of providing the surface comprises providing a surface with a coating applied to at least a portion thereof for altering the surface tension of the surface and thereby affecting the volume of the droplet deposited on the surface.

47. The dispensing method of claim 1 wherein the step of providing the surface comprises providing a surface with regions of differing surface tensions for affecting the deposition of the droplet thereon.

48. The dispensing method of claim 47 wherein the step of providing the surface with regions of differing surface tensions comprises providing a surface with hydrophilic wells surrounded by relatively hydrophobic areas.

49. The dispensing method of claim 1 wherein the step of providing the surface comprises providing a surface with a plurality of cylindrical columns disposed thereon for confining droplets that are deposited on the surface wherein the cylindrical columns have coatings applied thereto for modifying the surface tension of the cylindrical columns.

50. The dispensing method of claim 1 wherein the step of providing a surface for receiving the droplet comprises providing a substantially flat physical substrate.

51. The dispensing method of claim 1 wherein the step of providing a surface for receiving the droplet comprises providing a second dispensing member relative to which the droplet can be deposited.

52. The dispensing method of claim 51 wherein the step of providing a second dispensing member comprises providing a dispensing member with an inner volume for receiving the droplet.

53. The dispensing method of claim 52 wherein the step of providing a second dispensing member comprises providing a capillary tube.

54. The dispensing method of claim 11 further comprising the step of retaining the volume of liquid in the inner volume of the dispensing member for an amount of time sufficient to allow an incubation process to be completed in the volume of liquid.

55. The dispensing method of claim 54 further comprising a means for detecting a status of the process to be completed in the volume of liquid.

56. The dispensing method of claim 1 further comprising the step of providing a pre-existing droplet on the surface and wherein the droplet is deposited relative to the pre-existing droplet.

57. The dispensing method of claim 56 further comprising the step of drawing at least a portion of the droplet and at least a portion of the pre-existing droplet into an inner volume of a dispensing member.

58. The dispensing method of claim 57 further comprising the step of retaining the at least a portion of the droplet and the at least a portion of the pre-existing droplet in the inner volume of the dispensing member for an amount of time sufficient to allow a process to be completed between the at least a portion of the droplet and the at least a portion of the pre-existing droplet.

59. The dispensing method of claim 58 wherein the step of retaining the at least a portion of the droplet and the at least a portion of the pre-existing droplet comprises retaining the at least a portion of the droplet and the at least a portion of the pre-existing droplet for an amount of time sufficient to allow an incubation process to occur.

60. A method for adjusting a volume of an initial droplet on a surface, the method comprising the steps of:
providing a surface with an initial droplet of a given volume disposed thereon;
providing a dispensing member;
forming a bridge of liquid of a given volume between the dispensing member and the surface wherein the volume of the bridge of liquid includes the initial droplet; and
breaking the bridge of liquid between the dispensing member and the surface while leaving a remaining droplet of a different volume than the initial droplet.

61. The method of claim 40 wherein the step of providing a dispensing member comprises providing a dispensing member with an inner volume for retaining a volume of liquid and an orifice for allowing the passage of liquid therethrough and further comprising the step of providing a means for drawing a volume of liquid into the inner volume of the dispensing member.

62. The method of claim 61 wherein the step of forming the bridge of liquid between the dispensing member and the surface comprises contacting a proximal surface of the dispensing member with the initial droplet.

63. The method of claim 61 wherein the step of forming the bridge of liquid between the dispensing member and the surface comprises forming a bolus of liquid relative to the dispensing member and causing the bolus of liquid to make contact with the initial droplet thereby forming the bridge of liquid between the dispensing member and the surface.

64. The method of claim 63 further comprising aspirating a volume of liquid greater in volume than the volume of the bolus of liquid wherein the volume of liquid comprises at least a portion of the bolus of liquid and at least a portion of the initial droplet whereby the volume of the remaining droplet is less than the volume of the initial droplet.

65. The method of claim 63 further comprising aspirating a volume of liquid lesser in volume than the volume of the bolus of liquid whereby the volume of the remaining droplet is greater than the volume of the initial droplet.

66. The method of claim 63 wherein the step of causing the bolus of liquid to make contact with the initial droplet is performed by growing the bolus of liquid.

67. The method of claim 63 wherein the step of causing the bolus of liquid to make contact with the initial droplet includes moving the dispensing member into proximity with a location on the surface.

68. The method of claim 60 wherein the step of providing a surface with an initial droplet of a given volume disposed thereon comprises providing a surface and depositing a droplet relative to the surface with the dispensing member.

69. The method of claim 60 wherein the step of providing the dispensing member comprises providing a dispensing member with an open proximal end, an open distal end, and a channel between the proximal end and the distal end wherein the channel comprises the inner volume of the dispensing member.

70. The method of claim 69 wherein the step of providing the dispensing member comprises providing a capillary tube whereby the step of providing the means for retracting at least a portion of the bolus of liquid is performed at least partially by capillary forces exhibited by the capillary tube.

71. The method of claim 70 wherein the step of forming the bolus of liquid relative to the dispensing member comprises disposing a volume of liquid in the inner volume of the capillary tube and at least partially overcoming the capillary forces exhibited by the capillary tube to form the bolus of liquid at the proximal end of the capillary tube.

72. The method of claim 71 wherein the step of at least partially overcoming the capillary forces exhibited by the capillary tube comprises providing an increased pressure within the inner volume of the capillary tube.

73. The method of claim 72 wherein the step of providing an increased pressure within the inner volume of the capillary tube comprises providing an increased pressure of between approximately 0.01 and 10.0 Psi.

74. The method of claim 73 wherein the step of providing an increased pressure within the inner volume of the capillary tube comprises providing an increased pressure of approximately 0.06 Psi.

75. The method of claim 72 wherein the step of providing an increased pressure within the inner volume of the capillary tube comprises providing a pressure pulse of a given duration in the inner volume of the capillary tube.

76. The method of claim 75 wherein the step of providing a pressure pulse of a given duration comprises providing a pressure pulse of between 1 and 1000 milliseconds.

77. The method of claim 76 wherein the step of providing a pressure pulse of a given duration comprises providing a pressure pulse of between 3 and 15 milliseconds.

78. The method of claim 77 wherein the step of providing the capillary tube comprises providing a capillary tube with a body portion of an inside diameter between 0.4-0.7 mm and a nozzle with an inside diameter of between 0.02 and 0.24 mm.

79. The method of claim 75 wherein the step of providing a pressure pulse is performed with the proximal end of the capillary tube disposed between 10 and 3000 microns from the surface.

80. The method of claim 75 wherein the step of providing a pressure pulse is performed by opening a first valve, then opening a second valve, then closing the first valve wherein the first and second valves are plumbed in series.

81. The method of claim 60 further comprising the steps of detecting the actual volume of the remaining droplet and comparing the actual volume of the remaining droplet to a desired volume of the remaining droplet to determine any variation between the actual volume and the desired volume.

82. The method of claim 81 further comprising the step of adjusting the volume of the remaining droplet when the variation between the actual volume and the desired volume exceeds a predetermined variation whereby the dispensing method provides a closed-loop feedback and control system that can produce droplets of consistently accurate and controllable volumes.

83. The method of claim 82 wherein the step of adjusting the volume of the remaining droplet comprises forming a second bridge of liquid between the dispensing member and the surface and breaking the second bridge of liquid.

84. The method of claim 83 wherein the step of forming the second bridge between the proximal end of the capillary tube and the surface comprises forming a bolus of liquid relative to the proximal end of the capillary tube and causing the bolus of liquid to contact the remaining droplet.

85. The method of claim 83 wherein the step of forming the second bridge between the proximal end of the capillary tube and the surface comprises contacting the proximal end of the capillary tube with the remaining droplet.

86. The method of claim 84 further comprising drawing a volume of liquid greater than a volume of the bolus into the inner volume of the capillary tube and breaking the second bridge of liquid thereby reducing the volume of the remaining droplet.

87. The method of claim 84 further comprising retracting a volume of liquid less than a volume of the bolus into the inner volume of the capillary tube thereby increasing the volume of the remaining droplet.

88. A method for interacting with one or more droplets on a surface, the method comprising the steps of:
providing a surface with one or more droplets disposed thereon;
providing a dispensing member with an inner volume for retaining a volume of liquid and an orifice for allowing the passage of liquid therethrough;
providing a means for drawing a volume of liquid into the inner volume of the dispensing member;
forming a bridge of liquid between the dispensing member and the surface wherein the bridge of liquid includes one or more of the one or more droplets disposed on the surface;
drawing at least a portion of the bridge of liquid into the inner volume of the dispensing member wherein the at least a portion of the bridge of liquid includes at least a portion of the one or more droplets; and
breaking the bridge of liquid between the dispensing member and the surface;
whereby the at least a portion of the one or more droplets can be retained in the inner volume of the dispensing member.

89. The method of claim 88 wherein the step of providing a surface with one or more droplets disposed thereon comprises providing a surface with a plurality of droplets disposed thereon.

90. The method of claim 89 wherein the step of forming a bridge of liquid between the dispensing member and the surface comprises forming a bridge of liquid that includes a multiplicity of the plurality of droplets disposed on the surface and wherein the step of drawing at least a portion of the bridge of liquid into the inner volume of the dispensing member comprises drawing at least a portion of each of the multiplicity of droplets whereby the at least a portion of each of the multiplicity of droplets can be simultaneously retained in the inner volume of the dispensing member.

91. The method of claim 90 wherein the step of providing a surface with a plurality of droplets disposed thereon comprises providing a plurality of droplets with at least some of the droplets having different compositions from one another whereby the at least portions of the droplets having different compositions can be simultaneously retained in the inner volume of the dispensing member to allow an interaction therebetween.

92. The method of claim 91 further comprising the step of retaining the at least portions of the droplets having different compositions in the inner volume of the dispensing member for an amount of time sufficient to allow a process to occur.

93. The method of claim 92 further comprising the step of providing a means for detecting a status of the process.

94. The method of claim 88 wherein the step of forming the bridge of liquid between the dispensing member and the surface comprises contacting a proximal surface of the dispensing member with the one or more droplets.

95. The method of claim 88 wherein the step of forming the bridge of liquid between the dispensing member and the surface comprises forming a bolus of liquid relative to the dispensing member and causing the bolus of liquid to make contact with one or more of the one or more droplets thereby forming the bridge of liquid between the dispensing member and the surface.

96. The method of claim 95 wherein the step of causing the bolus of liquid to make contact with the one or more droplets is performed by growing the bolus of liquid.

97. The method of claim 95 wherein the step of causing the bolus of liquid to make contact with the one or more droplets includes moving the dispensing member into proximity with a location on the surface.

98. The method of claim 88 wherein the step of providing the dispensing member comprises providing a capillary tube whereby the step of providing the means for drawing a volume of liquid into the inner volume of the dispensing member is performed at least partially by capillary forces exhibited by the capillary tube.

99. The method of claim 95 wherein the step of forming the bolus of liquid relative to the dispensing member comprises disposing a volume of liquid in the inner volume of the capillary tube and at least partially overcoming the capillary forces exhibited by the capillary tube by providing an increased pressure within the inner volume of the capillary tube.

100. The method of claim 99 wherein the step of providing an increased pressure within the inner volume of the capillary tube comprises providing a pressure pulse of a given duration in the inner volume of the capillary tube.
